(19) United States
(12) Patent Application Publication
(10) Pub. No.: US 2026/0059595 A1
(43) Pub. Date: Feb. 26, 2026

(54) Link Recommendation For Multi-Link Operation

(71) Applicant: Cisco Technology, Inc., San Jose, CA (US)

(72) Inventors: Sachin D. Wakudkar, St. Sulpice (CH); Binita Gupta, San Diego, CA (US); Jegan Manoharan, Bangalore (IN); Brian Hart, Sunnyvale, CA (US)

(21) Appl. No.: 19/373,402

(22) Filed: Oct. 29, 2025

Related U.S. Application Data
(63) Continuation of application No. 18/984,993, filed on Dec. 17, 2024.
(60) Provisional application No. 63/634,821, filed on Apr. 16, 2024.

(51) Int. Cl. H04W 76/15; H04W 60/04; H04W 76/20

(52) U.S. Cl. CPC H04W 76/15; H04W 60/04; H04W 76/20

(57) ABSTRACT

Devices, networks, systems, methods, and processes for recommending one or more links to a station (STA) multi-link device (MLD) are provided herein. The STA MLD may be a part of a wireless network that includes a set of Access Points (AP) MLDs. An AP MLD of the set of AP MLDs may receive a connection management request of the STA MLD for one or more first links. Further, the AP MLD may determine that the first links are unavailable or partially available. Upon determining that the first links are unavailable or partially available, the AP MLD may transmit a connection management response including an indication that recommends a set of second links of the set of AP MLDs to the STA MLD. The transmission of the indication recommending the set of second links may enable the AP MLD to suppress connection failure(s) for the STA MLD.

### CROSS-REFERENCE TO RELATED APPLICATIONS

This application is a continuation of U.S. patent application Ser. No. 18/984,993, filed Dec. 17, 2024, which claims benefit of and priority to U.S. Provisional Application No. U.S. 63/634,821, filed Apr. 16, 2024, wherein the entirety of each are incorporated herein by reference.

The present disclosure relates to wireless networks. More particularly, the present disclosure relates to recommending a set of links of one or more access point multi-link devices (MLDs) to a station MLD.

### BACKGROUND

Wi-Fi, or wireless fidelity, has become a fundamental technology in today's world, enabling wireless connectivity across a broad spectrum of devices. The significance of Wi-Fi stems from the convenience and flexibility it offers, allowing for seamless Internet access and facilitating communication, data transfer, and various online activities. As a cornerstone of connectivity in homes, businesses, public spaces, and educational institutions, Wi-Fi assists in enhancing productivity and connectivity for individuals and organizations alike.

As technology has advanced, the role of Wi-Fi has evolved to meet growing demands for faster speeds, greater bandwidth, and improved security. These increasing demands have driven the continuous development of more advanced Wi-Fi standards, which are regularly updated to deliver enhanced performance, greater capacity, and improved efficiency. One notable advancement in Wi-Fi is the introduction of Multi-Link Operation (MLO). MLO allows stations (STAs) to connect (for example, using a single association) to one or more Access Points (APs) across multiple frequency bands, such as 2.4 Gigahertz (GHz), 5 GHZ, 6 GHZ, etc. The STAs can then utilize one or more of these frequency links for data transmissions depending on STAs capabilities. This MLO functionality enables higher data throughput, increased redundancy, higher reliability, lower latency, and more efficient use of network resources.

However, the MLO functionality may be often underutilized in practice. For example, stations may prioritize links operating on wider frequency bands, such as the 6 GHz band, over links operating on narrower frequency bands or different frequency bands when establishing connections. While this approach can assist in achieving higher throughput or reduced latency, it can also lead to an imbalance in link utilization. For example, the links operating on the wider frequency bands may be overutilized, while the links operating on the narrow frequency bands (or different frequencies) remain underutilized. This imbalance in link utilization may limit the efficiency of the MLO, which is designed to optimize the use of the entire spectrum.

Moreover, the imbalance in link utilization can further present various network performance challenges. For example, links operating on wider frequency bands may reach their maximum station capacity, resulting in connection failures for other stations attempting to join. These connection failures can lead to increased latency, packet loss, and a degraded user experience. Meanwhile, links operating on narrow frequency bands, which can accommodate more traffic, may remain neglected and underutilized. This may prevent the network from fully leveraging the available spectrum, thus impacting overall capacity and performance of the network.

### SUMMARY OF THE DISCLOSURE

Systems and methods for recommending a set of links of one or more Access Point (AP) multi-link devices (MLDs) to a station (STA) MLD in accordance with embodiments of the disclosure are described herein. In one aspect of the present disclosure, a network device is provided. The network device may comprise a processor and a memory communicatively coupled to the processor. The memory may comprise a Multi-Link Operation (MLO) management logic. The MLO management logic may be configured to receive a connection management request of an STA MLD for one or more first links. Further, the MLO management logic may be configured to determine that the one or more first links are one of unavailable or partially available. Furthermore, the MLO management logic may be configured to transmit, based on the determination that the one or more first links are unavailable or partially available, a connection management response including an indication that recommends a set of second links to the STA MLD.

In many embodiments, the network device may be a part of an AP MLD that provides connectivity on the one or more first links and the set of second links.

In one or more embodiments, based on the determination that the one or more first links are partially available, the connection management response may be configured to indicate partial availability for the one or more first links.

In a number of embodiments, prior to transmitting the connection management response, the MLO management logic may be further configured to remove one or more traffic identifiers of the STA MLD on the one or more first links based on the determination that the one or more first links are partially available.

In a variety of embodiments, the connection management response may further comprise another indication for the removal of the one or more traffic identifiers on the one or more first links.

In many additional embodiments, prior to transmitting the connection management response, the MLO management logic may be further configured to designate a traffic blocked status to the one or more first links for the STA MLD based on the determination that the one or more first links are partially available.

In many further embodiments, the connection management response may further comprise another indication for the traffic blocked status designated to the one or more first links.

In further embodiments, the MLO management logic may be further configured to determine whether the one or more first links have become available and map at least one traffic identifier of the STA MLD to the one or more first links based on the determination that the one or more first links have become available. The MLO management logic may be further configured to update the traffic blocked status designated to the one or more first links for the STA MLD to a traffic allowed status based on the mapping.

In additional embodiments, the MLO management logic may be further configured to compile a waiting list of STA MLDs for the one or more first links, where the waiting list comprises the STA MLD. In still additional embodiments, the MLO management logic may be further configured to determine whether the one or more first links have become available and identify a highest prioritized STA MLD in the waiting list based on the determination that the one or more first links have become available. In still yet additional embodiments, the MLO management logic may be further configured to permit traffic access for the highest prioritized STA MLD on the one or more first links.

In various embodiments, based on the determination that the one or more first links are unavailable, the connection management response may be configured to indicate a rejection status for the one or more first links.

In more embodiments, the network device may be a part of a first Access Point (AP) MLD, and connectivity on the set of second links may be provided by a second AP MLD different from the first AP MLD. In still more embodiments, the connection management response may further comprise a first indication of a first preference value for the second AP MLD.

In still yet more embodiments, the connection management response may comprise one or more Neighbor Report elements, where the first indication is included in a Neighbor Report element of the one or more Neighbor Report elements. The preference value indicated by the first indication is for the second AP MLD indicated in a Basic Multi-Link element within the Neighbor Report element.

In yet more embodiments, the connection management response may further comprise a second indication of a second preference value for a third AP MLD that is part of an excluded Basic Service Set.

In several more embodiments, the connection management response may further comprise a second indication of a set of second preference values for one or more affiliated APs in a third AP MLD, where the one or more affiliated APs may be a part of an excluded Basic Service Set.

In numerous embodiments, the network device may be a part of the first AP MLD, and connectivity on the set of second links may be provided by a plurality of affiliated APs in a second AP MLD different from the first AP MLD.

In numerous additional embodiments, the connection management response may further comprise a plurality of preference indications. A preference indication of the plurality of preference indications may be configured to indicate a preference value for a subset of affiliated APs of the plurality of affiliated APs in the second AP MLD.

In further additional embodiments, the connection management response may further comprise a plurality of Neighbor Report elements, where the preference indication is included in a Neighbor Report element of the plurality of Neighbor Report elements, and the preference value indicated by the preference indication is for the subset of affiliated APs indicated in a Basic Multi-Link element within the Neighbor Report element.

In several embodiments, the connection management request may comprise one of: an association request, a (Re)association request, a Basic Service Set (BSS) Transition Management (BTM) query, a BTM response, a first authentication frame, a link reconfiguration request, a frame transfer request frame, or a Neighbor Report request. In various embodiments, the connection management response may comprise one of: an association response, a (Re)association response, a Neighbor Report response, a link reconfiguration response, a BTM request, a frame transfer response frame, or a second authentication frame.

In another aspect of the present disclosure, a station is provided. The station may comprise a processor and a memory communicatively coupled to the processor. The memory may comprise an MLO management logic. The MLO management logic may be configured to transmit a connection management request for one or more first links of a first AP MLD. Further, the MLO management logic may be configured to receive, based on the transmission of the connection management request and the one or more first links being unavailable, an indication that recommends a set of second links of one of the first AP MLD or a second AP MLD. Furthermore, the MLO management logic may be configured to transmit a new connection management request for at least one second link of the set of second links.

In yet another aspect of the present disclosure, a method is provided. The method may comprise receiving a connection management request of an STA MLD for one or more first links. Further, the method may comprise determining that the one or more first links are unavailable or partially available. Furthermore, the method may comprise transmitting, based on the determination that the one or more first links are unavailable or partially available, a connection management response including an indication that recommends a set of second links to the STA MLD.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual network diagram of various environments in which a Multi-Link Operation (MLO) management logic can operate on a plurality of network devices in accordance with various embodiments of the disclosure;

FIG. 2 is a conceptual block diagram of a network environment for link recommendation in accordance with various embodiments of the disclosure;

FIG. 3 is a conceptual block diagram of another network environment for the link recommendation in accordance with various embodiments of the disclosure;

FIG. 4 is a flowchart depicting a process for transmitting a link recommendation indication in accordance with various embodiments of the disclosure;

FIG. 5 is a flowchart depicting a process for transmitting at least one of the link recommendation indication or a link status indication in accordance with various embodiments of the disclosure;

FIG. 6 is a flowchart depicting a process for managing partial success on a requested link in accordance with various embodiments of the disclosure;

FIG. 7 is a flowchart depicting a process for permitting traffic access in accordance with various embodiments of the disclosure;

FIG. 8 is a flowchart depicting a process for transmitting a plurality of Neighbor Report elements in accordance with various embodiments of the disclosure;

FIG. 9 is a flowchart depicting a process for transmitting one or more Neighbor Report elements in accordance with various embodiments of the disclosure;

FIG. 10 is a flowchart depicting a process for transmitting one or more connection management requests in accordance with various embodiments of the disclosure; and

FIG. 11 is a conceptual block diagram of a device suitable for configuration with the MLO management logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein for recommending one or more links to a station (STA) multi-link device (MLD). As used herein, the STA MLD may correspond to a client device that is provided with a Multi-link Operation (MLO) functionality. This MLO functionality may allow the STA MLD to connect to one or more APs by utilizing multiple frequency bands, such as 2.4 (Gigahertz) GHz, 5 GHZ, 6 GHZ, etc. Accordingly, the MLO functionality may enable the STA MLD to achieve higher data throughput, increased redundancy, and more efficient use of network resources. However, the MLO functionality may be often underutilized in practice. For example, STA MLDs may prioritize links operating on wider frequency bands, such as the 6 GHz band, over links operating on narrower frequency bands or different frequency bands when establishing connections. While this approach can assist in achieving higher throughput or reduced latency, it can also lead to an imbalance in link utilization. For example, the links operating on the wider frequency bands may be overutilized, while the links operating on the narrow frequency bands (or different frequencies) remain underutilized. This imbalance in link utilization may limit the efficiency of the MLO, which is designed to optimize the use of the entire spectrum. Moreover, the imbalance in link utilization can pose various network performance challenges. For example, the links on the wider frequency bands may reach their maximum client-handling capacity, resulting in connection failures for other STA MLDs attempting to join. To this end, the present disclosure provides a network device that suppresses the connection failures for the STA MLD by recommending a set of links of a set of AP MLDs that are available for connection.

In a variety of embodiments, the STA MLD may be a part of a wireless network. The wireless network may include a Wireless Local Area Network (LAN) Controller WLC and/or a set of AP MLDs. For example, the set of AP MLDs may include a first AP MLD, a second AP MLD, and a third AP MLD. Each AP MLD of the set of AP MLDs may correspond to either a single AP that includes multiple radios for supporting MLO, or a set of affiliated APs (for example, each affiliated AP with at least one radio) that collectively supports MLO. As used herein, an AP, multi-link or otherwise, may refer to a device that allows one or more STAs (e.g., the STA MLD) to connect to a network (e.g., the Internet) or to other STAs. As used herein, the WLC may include a device that manages the set of AP MLDs to ensure efficient data routing, security, and configuration. In a number of embodiments, the network device may correspond to one of the WLC or an AP MLD of the set of AP MLDs.

In many embodiments, devices and methods may provide MLD level recommendations (to either all links or a subset of links) when association or authentication fails for a non-AP MLD; and signal to an excluded AP MLD or a subset of affiliated APs of an AP MLD that is not accepting new associations (e.g. due to being overloaded), thus avoiding client failures. For example, enhancements may be used to address gaps in the 802.11be specification. By way of non-limiting example, in 802.11be, neighbor report elements are extended to include a basic Multi-Link element. For example, the BTM procedure for MLDs (clause 35.3.23) may be enhanced to make use of a basic ML element in the neighbor report element to recommend an AP MLD or a subset of affiliated APs of an AP MLD to a non-AP MLD, for superior BSS transition.

In additional embodiments, the neighbor report element is also returned by the AP MLD in other frames for suggesting neighboring APs for BSS transition, including: 1) in the (Re) Association Response frame and Authentication frame when rejected with status code of REJECTED_WITH_SUGGESTED_BSS_TRANSITION; and/or 2) in a neighbor report response frame, sent in response to a neighbor report request from the STA. It should be appreciated that in these frames, the AP may also recommend an AP MLD or a subset of affiliated APs of an AP MLD using a basic ML element in the neighbor report element, for assisting STAs/non-AP MLD to achieve better BSS transition. However, for these frames, the 802.11be specification does not define a procedure to recommend AP MLD or a subset of affiliated APs of an AP MLD.

In many embodiments, in Multi-Link Operation (MLO), if authentication or (re) association fails for a non-Access Point Multi-Link Device (MLD), the Access Point Multi-Link Device (AP MLD) can reply with an Authentication or (Re) Association response frame. In this frame, a status code field may be set to “REJECTED_WITH_SUGGESTED_BSS_TRANSITION”, for example, and it may contain one or more neighbor report elements. In additional embodiments, the neighbor report information may be enhanced within these frames to suggest another AP MLD (with all or a subset of links recommended) or the same AP MLD with a different set of links recommended. It is envisioned that this enhancement allows a non-AP MLD to potentially associate with either the same AP MLD (with a different link set) or another AP MLD. However, this specific procedure is not defined in the 802.11be specification.

In additional embodiments, to implement this functionality, an authentication or (Re) Association Response frame, with a status code field set to “REJECTED_WITH_SUGGESTED_BSS_TRANSITION”, may contain one or more neighbor report elements, subject to one or more of the following guidelines. It should be appreciated that this status code may be indicate in many different ways, without exceeding beyond the spirit and scope of the instant disclosure. For example, each neighbor report element may include a basic Multi-Link element describing the preference for a potential AP MLD candidate. In still additional embodiments, a preference field value within a neighbor report element may indicate the preference for the specified AP MLD.

In many embodiments, for a neighbor report element containing a basic Multi-Link element, it is envisioned that the AP MLD may adhere to one or more rules outlined in the 802.11be amendment (pertaining to BTM requests) to indicate preference for a reported AP MLD. This preference may either exclude specific affiliated APs/links or recommend only a subset of them. It is envisioned that multiple neighbor report elements may report the same AP MLD while recommending different subsets of affiliated APs, according to the rules specified in the 802.11be amendment. For example, a neighbor report can have the same or different preference field values. In many embodiments, neighbor report element(s) with a preference field value of 0 may be included to denote an excluded AP MLD or excluded affiliated APs of an AP MLD, following the same guidelines as described in clause 35.3.23 (BSS transition management for MLDs).

In still additional embodiments, the neighbor report response frame may convey or otherwise communicate one or more neighbor report elements, adhering to the 802.11 standard, to furnish the STA with information regarding neighboring APs. For example, an enhancement to neighbor report elements contained within the neighbor report response frame may be desirable. In many embodiments, this enhancement involves incorporating a basic multi-link element, utilizing it to express a preference either for a reported AP MLD without specific recommendations regarding affiliated APs, or for a reported AP MLD with only a subset of recommended affiliated APs. In many embodiments, this approach is similar to embodiments utilizing the basic ML element within the neighbor report element for (Re)association response and authentication frames.

In many embodiments, for example with respect to the 802.11 standard, the BTM request may employ a preference field value of “0” within a neighbor report element, signaling that the BSS corresponding to a reported neighbor AP is designated as an excluded BSS, thereby advising the STA against association with the corresponding BSS. In numerous embodiments, this functionality may be extended to encompass MLO scenarios. In these cases, either an entire AP Multi-Link Descriptor (MLD) could be designated for exclusion or a subset of affiliated APs within an AP MLD could be excluded from association. For instance, this scenario might arise when all APs within an AP MLD are overloaded, necessitating the exclusion of the entire AP MLD from accepting new associations, or when only a subset of affiliated APs within an AP MLD are overloaded, leading to the exclusion of only those specific affiliated APs from new associations.

In additional embodiments, a preference field value of “0” with the basic Multi-Link (ML) element may be combined with a Neighbor report element, serving to signify either an excluded AP Multi-Link Descriptor (MLD) or a set of excluded affiliated APs within an AP MLD. For example, for any frame containing a neighbor report element featuring a basic Multi-Link element, a preference field value of “0” within a neighbor report element, which incorporates a Basic Multi-Link element delineating a reported AP MLD without enumerating specific affiliated APs, may indicate the exclusion of the reported AP MLD, prompting non-AP MLDs to abstain from associating with it.

In still additional embodiments, a preference field value of “0” within a neighbor report element, encompassing a basic Multi-Link element describing a reported AP MLD while listing a subset of affiliated APs, denotes the exclusion of all listed affiliated APs associated with the reported AP MLD, thus advising non-AP MLDs against associating with any of those specified affiliated APs. However, other affiliated APs of the AP MLD remain available for Multi-Link association.

In still additional embodiments, the indication with preference field value “0” and basic ML element may indicate information regarding one or more excluded AP MLDs, and can be signaled in one or more of the following frames, either alone or in combination, and without limitation: BTM request frame; authentication frame or (Re) Association response that has the status code field set to “REJECTED_WITH_SUGGESTED_BSS_TRANSITION”; and/or a neighbor report response frame.

In various embodiments, the network device may be configured to receive a connection management request of the STA MLD for at least one first link. For example, the first link may be utilized by the first AP MLD to provide connectivity. In various examples, the connection management request may include an association request, a (Re)association request, a Basic Service Set (BSS) Transition Management (BTM) query, a BTM response, a first authentication frame, a link reconfiguration request, a frame transfer request frame, or a Neighbor Report request. In an example, the connection management request may include a Service Set Identifier (SSID) of the network, an identifier (e.g., a Media Access Control “MAC” address) of the STA MLD, at least one frequency band supported by the STA MLD, at least one link identifier of the first link, or the like.

In many embodiments, upon receiving the connection management request, the network device may determine whether the first link is available based on one or more parameters of the first link. In an example, the parameters of the first link may include a link configuration parameter, a link utilization parameter, or the like. For example, the link configuration parameter may indicate a maximum number of STAs that can connect to the first link. The link utilization parameter may indicate a maximum channel utilization value, beyond which the first link becomes unavailable or partially available for new clients. In many examples, the network device may determine that the first link is available if a number of STAs connected to the first link is less than the maximum number of STAs. In further examples, the network device may determine that the first link is available if a channel utilization value of the first link is less than the maximum channel utilization value. Conversely, if the number of STAs connected to the first link is not less than the maximum number of STAs, the network device may determine that the first link is unavailable or partially available. Further, if the channel utilization value of the first link is not less than the maximum channel utilization value, the network device may determine that the first link is unavailable or partially available.

In many additional embodiments, if the first link is available, the network device may permit the association of the STA MLD to the network device using the first link. Upon permitting the association, the network device may transmit a connection management response indicating that the association of the STA MLD is successful. In many further embodiments, if the first link may be unavailable for traffic access but is partially available, the network device may permit partial association of the STA MLD to the first link without providing traffic access for the STA MLD on the first link.

In further embodiments, to permit the association without providing the traffic access, the network device may remove one or more Traffic Identifiers (TIDs) for the STA MLD on the first link. Further, the network device may designate a traffic blocked status to the first link for the STA MLD. Upon permitting the association without providing the traffic access, the network device may generate a first status code indication indicating a partial success of the association of the STA MLD.

In still further embodiments, upon generating the first status code indication, the network device may obtain link information of each AP MLD of the set of AP MLDs. For example, the link information of a specific AP MLD of the set of AP MLDs may include a link identifier for each link of one or more links of the specific AP MLD, a number of STAs connected to each link of the links, a channel utilization value of each link of the links, or the like. In various examples, the link information may be maintained by the network device. In some more examples, the link information may be acquired by the network device by executing a Neighbor Discovery Protocol (NDP) with one or more AP MLDs of the set of AP MLDs. Further, the network device may determine, based on the link information, a set of second links of the set of AP MLDs that are available for the association of the STA MLD. For example, the network device may determine a specific link of the set of AP MLDs as a second link of the set of second links, if the number of STAs connected to the specific link is less than the maximum number of STAs allowed to connect to the specific link and/or the channel utilization value of the specific link is less than the maximum channel utilization value of the specific link.

In still yet further embodiments, upon determining the set of second links, the network device may generate a link recommendation indication that recommends the set of second links for the association of the STA MLD. In an example, the link recommendation indication may include one or more identifiers for the set of second links. Upon generating the link recommendation indication, the network device may transmit a connection management response to the STA MLD. In various examples, the connection management response may correspond to an association response, a (Re)association response, a Neighbor Report response, a link reconfiguration response, a BTM request, a frame transfer response frame, or a second authentication frame. The link recommendation indication may be provided in one or more Neighbor Report elements included in the connection management response.

In further additional embodiments, prior to transmitting the connection management response, the network device may generate a TID-To-Link Mapping (TTLM) indication. In an example, the TTLM indication may indicate a mapping of a preset TID value to the first link, where the preset TID value may be “0”. Further, the TTLM indication may indicate the traffic blocked status of the first link. The network device may further include the TTLM indication in the connection management response transmitted to the STA MLD.

In additional embodiments, upon receiving the connection management response, the STA MLD may be configured to identify the link status indication indicating the partial success of the association of the STA MLD. Upon identifying the link status indication, the STA MLD may determine whether the connection management response includes the link recommendation indication. If the connection management response does not include the link recommendation indication, the STA MLD may re-transmit the connection management request in order to receive the link recommendation indication. Conversely, if the connection management response includes the link recommendation indication, the STA MLD may identify an optimal second link among the set of second links. In various examples, the STA MLD may identify, as the optimal second link, a second link of the set of second links that can achieve a specific data throughput required for the STA MLD and/or support a specific power configuration required by the STA MLD. Upon identifying the optimal second link, the STA MLD may transmit a new connection management request for at least one second link (e.g., the optimal second link) of the set of second links.

In still yet additional embodiments, the network device may determine whether the first link is available. If the first link is still not available, the network device may wait until the first link becomes available. If the first link becomes available, the network device may permit the association of the STA MLD with traffic access by mapping at least one TID for the STA MLD and/or updating the traffic blocked status of the first link to a traffic allowed status.

In numerous embodiments, the network device may compile a waiting list of STA MLDs for the first link to include the STA MLD that is waiting for the first link to become available. Specifically, the waiting list of STA MLDs may be complied to include the identifier of the STA MLD. In various examples, the waiting list of STA MLDs may include one or more identifiers of one or more STA MLDs that are waiting for the first link to become available. If the first link becomes available, the network device may identify a highest prioritized STA MLD in the waiting list based on a priority order of the waiting list. In various examples, the priority order may prioritize the STA MLDs in the waiting list based on a First Come, First Serve (FCFS) order. In some more examples, the priority order may prioritize enterprise STAs over guest STAs. Upon identifying the highest prioritized STA MLD, the network device may permit the association of the highest prioritized STA MLD with the traffic access as the first link becomes available.

In more embodiments, if the first link is unavailable, the network device may reject the association of the STA MLD to the first link. Upon rejecting the association, the network device may generate a second status code indication (e.g., rejection status) indicating that the association of the STA MLD is rejected with at least one Basic Service Set (BSS) transition suggestion. Upon generating the second status code indication, the network device may determine the set of second links of the set of AP MLDs based on the link information of each AP MLD of the set of AP MLDs. Upon determining the set of second links, the network device may generate a plurality of Neighbor Report elements for the set of AP MLDs. For example, if the set of second links includes one or more available links of the first AP MLD and/or a plurality of available links of the second AP MLD, the network device may generate a first Neighbor Report element for the first AP MLD and a second Neighbor Report element for the second AP MLD.

In still more embodiments, the first Neighbor Report element may include a first preference indication and a first Basic Multi-Link element. The first preference indication may indicate a first preference value for the first AP MLD indicated by the first Basic Multi-Link element. In yet more embodiments, the second AP MLD may correspond to a single AP having multiple radios, where the plurality of available links of the second AP MLD are linked to or operate through the multiple radios. In such a scenario, the second Neighbor Report element may include a second preference indication and a second Basic Multi-Link element. The second preference indication may indicate a second preference value for the second AP MLD indicated by the second Basic Multi-Link element. In still yet more embodiments, the second AP MLD may include a set of affiliated APs of which a subset of affiliated APs may be available for association. In such a scenario, the second Neighbor Report element may include a second preference indication and a second Basic Multi-Link element. The second preference indication may indicate a second preference value for the subset of affiliated APs indicated by the second Basic Multi-Link element.

In numerous additional embodiments, the network device may further determine, based on the link information, whether the set of AP MLDs includes an excluded AP MLD or an excluded affiliated AP of an AP MLD. As used herein, the excluded affiliated AP may refer to an affiliated AP that is excluded from associating with the STA MLD. As used herein, the excluded AP MLD may refer to an AP MLD of the set of AP MLDs whose all associated links are excluded from association with the STA MLD. The excluded AP MLD may also be referred to as a part of an excluded BSS or as a part of an excluded Extended Service Set (ESS). In various examples, the network device may determine that the third AP MLD is an excluded AP MLD.

In several embodiments, upon determining the third AP MLD as the excluded AP MLD, the network device may generate a third Neighbor Report element for the third AP MLD. The third Neighbor Report element may include a third preference indication and a third Basic Multi-Link element. The third preference indication may have a third preference value of, for example, ‘0’, for the third AP MLD indicated in the third Basic Multi-Link element. The third preference indication indicating the third preference value, for example, ‘O’ may be included to dissuade the STA MLD from connecting to the excluded Basic Service Set or excluded ESS.

In several more embodiments, upon generating the plurality of Neighbor Report elements (such as the first Neighbor Report element, the second Neighbor Report element, and/or the third Neighbor Report element), the network device may transmit, to the STA MLD, a connection management response that includes the plurality of Neighbor Report elements.

In one or more embodiments, an AP MLD may receive a connection management request of an STA MLD requesting a first link. If the AP MLD determines that the first link requested by the STA MLD is unavailable for partial association and complete association, the AP MLD may determine whether other links of the AP MLD are available for a partial association or a complete association. In a scenario where the AP MLD determines that there is at least one second link available on which the STA MLD can associate, the AP MLD may transmit a connection management response to the STA MLD. The connection management response may indicate to the STA MLD that the connection is successful on the at least one second link instead of the requested first link, and the that the STA MLD can operate on the at least one second link. In other words, instead of providing a rejection status for the requested first link in the connection management response, the AP MLD can provide a connection successful status for the least one second link and one or more details of the least one second link in the connection management response. In addition, the AP MLD can further recommend one or more other second links, belonging to the same AP MLD or a different AP MLD, that the STA MLD can connect to in the connection management response.

Although the connection management request corresponding to one of the association request, the (Re)association request, or the authentication frame is disclosed, the scope of the present disclosure is not limited to it. In some more embodiments, the connection management request may correspond to one of a Neighbor Report request, a BSS Transition Management (BTM) query, a BTM response, a frame transfer request frame, or a link reconfiguration request. In some more examples, upon receiving the Neighbor Report request (or the link reconfiguration request, the BTM query, the frame transfer request), the network device may transmit a Neighbor Report response (or a link reconfiguration response, a BTM response, a frame transfer response) that includes at least one of the first Neighbor Report element of the first AP MLD, the second Neighbor Report element of the second AP MLD, or the third Neighbor Report element of the third AP MLD.

Advantageously, determining that the first link is unavailable may trigger the network device to transmit the connection management response including the link recommendation indication. The transmission of the connection management response may trigger the STA MLD to utilize the link recommendation indication to connect to one or more second links. Accordingly, if the first link is unavailable, the network device may enable the STA MLD to connect to one or more second links that are available, which in turn enables the network device to suppress the connection failures for the STA MLD. Further, enabling the STA MLD to utilize the set of second links may enable the wireless network including the set of AP MLDs to fully leverage the available spectrum utilized by the set of APs. Therefore, the network performance of the wireless network may be improved.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

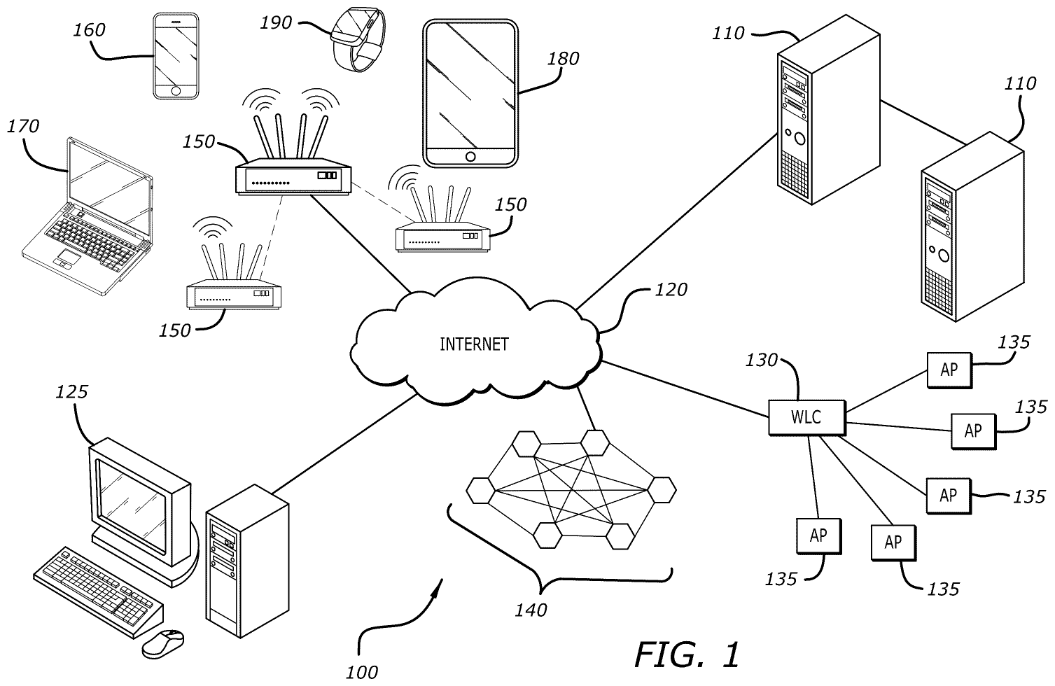

Referring to FIG. 1, a conceptual network diagram 100 of various environments in which a Multi-Link Operation (MLO) management logic can operate on a plurality of network devices in accordance with various embodiments of the disclosure is shown. Those skilled in the art will recognize that the MLO management logic may include various hardware and/or software deployments and may be configured in a variety of ways. In many embodiments, the MLO management logic may be configured as a standalone device, exist as a logic in another network device, be distributed among various network devices operating in tandem, or be remotely operated as part of a cloud-based network management tool. In further embodiments, one or more servers 110 may be configured with the MLO management logic or may otherwise operate as the MLO management logic. In many further embodiments, the MLO management logic may operate on the one or more servers 110 connected to a communication network 120 (e.g., the “Internet”). The communication network 120 may include wired networks or wireless networks. The MLO management logic may be provided as a cloud-based service that may service remote networks, such as, but not limited to a deployed network 140.

However, in additional embodiments, the MLO management logic may be operated as a distributed logic across multiple network devices. In the embodiments depicted in FIG. 1, a plurality of Access Points (APs) 150 may operate as the MLO management logic in a distributed manner or may have one specific device operate as the MLO management logic for all of the neighboring or sibling APs 150. The APs 150 may facilitate Wi-Fi connections for various electronic devices, such as but not limited to, client devices 160-190 including at least one laptop computer 170, at least one cellular phone 160, at least one portable tablet computer 180, and at least one wearable computing device 190.

In numerous embodiments, the MLO management logic may be integrated within another network device. In an example, a wireless LAN controller (WLC) 130 may be configured with the MLO management logic or may otherwise operate as the MLO management logic. The WLC 130 or a cloud service may control operations of a set of APs 135 that are connected, either wired or wirelessly, to the WLC 130. In more embodiments, a personal computer 125 may be utilized to access and/or manage various aspects of the MLO management logic, either remotely or within the network itself. In the embodiments depicted in FIG. 1, the personal computer 125 communicates over the communication network 120 and may access the MLO management logic of the servers 110, the APs 150, or the WLC 130.

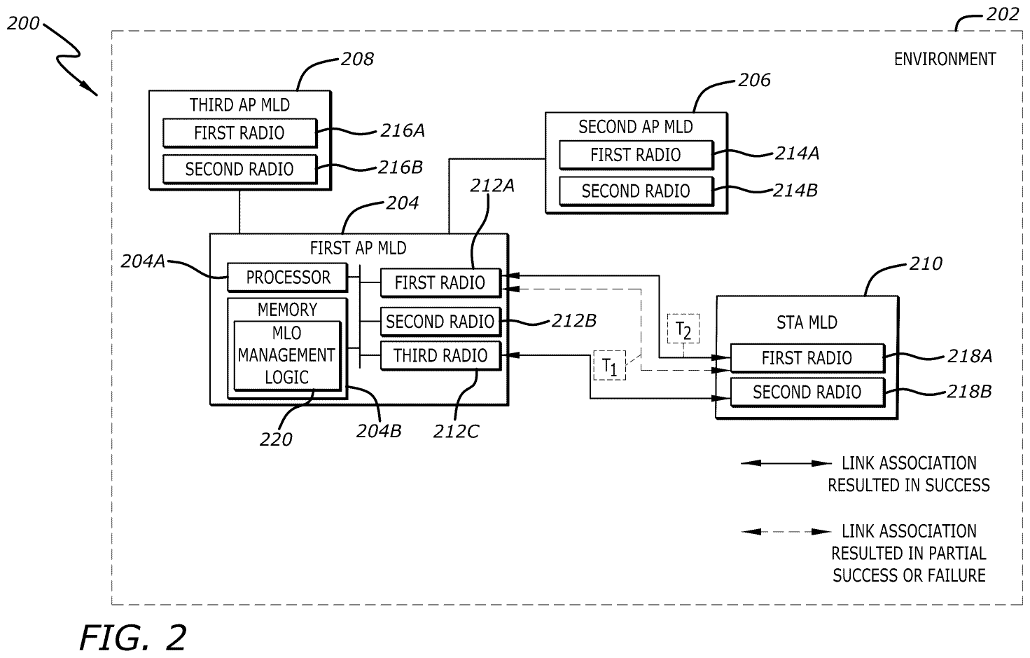

Although a specific embodiment for various environments that the MLO management logic may operate on a plurality of network devices suitable for carrying out the various steps, processes, methods, and operations described herein is discussed with respect to FIG. 1, any of a variety of systems and/or processes may be utilized in accordance with embodiments of the disclosure. In many non-limiting examples, the MLO management logic may be provided as a device or software separate from the WLC 130 or the MLO management logic may be integrated into the WLC 130. The elements depicted in FIG. 1 may also be interchangeable with other elements of FIGS. 2-11 as required to realize a particularly desired embodiment.

Referring to FIG. 2, a conceptual block diagram 200 of a network environment 202 for link recommendation in accordance with various embodiments of the disclosure is shown. In the embodiments shown in FIG. 2, the network environment 202 may include a set of AP multi-link devices (MLDs) 204-208 and a station (STA) MLD 210. The set of AP MLDs 204-208 may include a first AP MLD 204, a second AP MLD 206, and a third AP MLD 208. Each AP MLD of the set of AP MLDs 204-208 may be connected to each other AP MLD of the set of AP MLDs 204-208 via a wired connection or a wireless connection. For example, the first AP MLD 204 may be connected to the second AP MLD 206 and/or the third AP MLD 208 via the wired connection or the wireless connection. Similarly, the second AP MLD 206 can also be connected to the third AP MLD 208.

Although the network environment 202 including three AP MLDs 204-208 is shown, the scope of the present disclosure is not limited to it. For example, the network environment 202 may include at least one AP MLD. As used herein, the AP MLD may correspond to either a single AP that includes multiple radios for supporting the MLO, or a set of affiliated APs, each AP with one radio, that collectively supports the MLO. As used herein, an AP, multi-link or otherwise, may refer to a device that allows one or more STAs (e.g., the STA MLD 210) to connect to a network (e.g., the Internet) or other STAs. As used herein, the STA MLD 210 may refer to a mobile computing device that includes multiple radios for supporting the MLO. For example, the mobile computing device may include a smartphone, a tablet, a laptop/notebook, a wearable device, or the like. Although the network environment 202 including a single STA MLD 210 is shown, the scope of the present disclosure is not limited to it. For example, the network environment 202 may additionally (or alternatively) include a plurality of STAs, each having at least one radio.

In the embodiments shown in FIG. 2, the first AP MLD 204 may include a processor 204A and a memory 204B communicatively coupled to the processor 204A. The processor 204A may include suitable logic, circuitry, and interfaces that are configured to execute instructions stored in the memory 204B. For example, the processor 204A may correspond to an application-specific integrated circuit (ASIC) processor, a complex instruction set computing (CISC) processor, a central processing unit (CPU), an explicitly parallel instruction computing (EPIC) processor, a very long instruction word (VLIW) processor, and/or other processors or circuits. The memory 204B may comprise suitable logic, circuitry, and interfaces that are configured to store a machine code and/or the instructions executable by the processor 204A. For example, the memory 204B may correspond to random access memory (RAM), read only memory (ROM), electrically erasable programmable read-only memory (EEPROM), hard disk drive (HDD), a solid-state drive (SSD), a CPU cache, and/or a secure digital (SD) card. Similarly, each of the second AP MLD 206 and the third AP MLD 208 can also include a processor and a memory.

In a number of embodiments, the first AP MLD 204 may include a set of radios 212A-212C including a first radio 212A, a second radio 212B, and a third radio 212C. The set of radios 212A-212C may be communicatively coupled to at least one of the processor 204A or the memory 204B. Each radio of the set of radios 212A-212C may include a communication interface that is configured to transmit (and/or receive) Radio Frequency (RF) signals to facilitate wireless communication with the STA MLD 210. For example, the communication interface may include a transceiver, an antenna, a digital signal processor (DSP), one or more amplifiers, or the like.

In a variety of embodiments, each radio of the set of radios 212A-212C may be configured to operate on at least one specific frequency band. For example, the specific frequency band may include one of a 2.4 Gigahertz (GHz) band, a 5 GHz band, a 6 GHz band, or the like. Each radio of the set of radios 212A-212C may support at least one link. As used herein, the link may refer to a wireless connection established between a specific radio of an AP (e.g., the first AP MLD 204) and its communication counterpart. For example, the link may include at least one of a 2.4 GHz link, a 5 GHz link, or a 6 GHz link based on the operating frequency band of the specific radio of the AP. In various examples, the link may be provided with a link identifier (e.g., a virtual address) that can be utilized to uniquely identify the link within the network environment 202.

Although the first AP MLD 204 having three radios 212A-212C is shown, the scope of the present disclosure is not limited to it. For example, the first AP MLD 204 may include two or more radios. Similar to the first AP MLD 204, each of the second AP MLD 206, the third AP MLD 208, and the STA MLD 210 may include a set of radios 214A and 214B, a set of radios 216A and 216B, and a set of radios 218A and 218B, respectively.

In various embodiments, the network environment 202 may be provided with an MLO management logic 220. The MLO management logic 220 may be configured to provide at least one link recommendation that recommends a set of links of one or more AP MLDs of the set of AP MLDs 204-208 for an association of the STA MLD 210. In various examples, the MLO management logic 220 may be embodied within at least one AP MLD of the set of AP MLDs 204-208. For the embodiments shown in FIG. 2, the MLO management logic 220 may be embodied within the first AP MLD 204. Specifically, the MLO management logic 220 may be embodied within the memory 204B of the first AP MLD 204. Although it is shown that the MLO management logic 220 is embodied within the memory 204B, the scope of the present disclosure is not limited to it. In an example, the MLO management logic 220 may be embodied within the processor 204A of the first AP MLD 204 or may be provided as a standalone entity (e.g., a controller) within the first AP MLD 204.

In various embodiments, when the STA MLD 210 is located within a geographical area serviced by the first AP MLD 204, the STA MLD 210 may be configured to receive one or more beacon frames broadcasted by the first AP MLD 204. For example, each beacon frame may include a Service Set Identifier (SSID) of the network, an identifier (e.g., a Media Access Control “MAC” address) of a radio of the set of radios 212A-212C, the frequency band supported by the radio, a link identifier of the link supported by the radio, or the like. Upon receiving the beacon frames, the STA MLD 210 may be configured to transmit a connection management request to the first AP MLD 204. In various examples, the connection management request may include an association request (or a (Re)association request) for an association of the STA MLD 210 to a first link of the first AP MLD 204, for example, the first link supported by the first radio 212A of the first AP MLD 204. In an example, the association request (or the (Re)association request) may include an SSID of the network, an identifier (e.g., a MAC address) of the STA MLD 210, at least one frequency band supported by a first radio 218A of the STA MLD 210, a link identifier of the first link, or the like. In some more examples, the connection management request may include a request in a first authentication frame. In further examples, the connection management request may include a Neighbor Report request or a link reconfiguration request. In many further examples, the connection management request may include a Basic Service Set (BSS) Transition Management (BTM) query, a BTM response, frame transfer request frame, or the like.

In many embodiments, upon receiving the connection management request, the first AP MLD 204 may be configured to determine whether the first link is available for the association of the STA MLD 210. In various examples, the first AP MLD 204 may determine whether the first link is available, partially available, or unavailable based on one or more parameters of the first link. For example, the parameters of the first link may include a link configuration parameter, a link utilization parameter, or the like. In an example, the link configuration parameter may indicate the maximum number of STAs that can connect to the first link. The link utilization parameter may indicate a maximum channel utilization value, beyond which the first link becomes unavailable. For instance, if the number of STAs connected to the first link is less than the maximum number of STAs, the first AP MLD 204 may determine that the first link is available for the association of the STA MLD 210. Likewise, if the channel utilization value of the first link is less than the maximum channel utilization value, the first AP MLD 204 may determine that the first link is available for the association of the STA MLD 210. Conversely, if the number of STAs connected to the first link is not less than the maximum number of STAs, the first AP MLD 204 may determine that the first link is unavailable for the association of the STA MLD 210. Further, if the channel utilization value of the first link is not less than the maximum channel utilization value, the first AP MLD 204 may determine that the first link is unavailable or partially available for the association of the STA MLD 210. For the embodiments shown in FIG. 2, at a time instance T=T₁, the first AP MLD 204 may determine that the first link is partially available for the association of the STA MLD 210.

Upon determining that the first link is partially available, the first AP MLD 204 may permit partial association of the STA MLD 210 on the first link. Partial association on a link may correspond to an association without providing traffic access on the link. Prior to permitting partial association, the first AP MLD 204 may determine whether the STA MLD 210 is compatible for partial association. For example, if the STA MLD 210 is compatible for partial association, the first AP MLD 204 may permit the partial association of the STA MLD 210 on the first link. Association without traffic access may be allowed due to partial availability of the first link. Upon permitting the partial association of the STA MLD 210 on the first link, the first AP MLD 204 may generate a first status code indication. In an example, the first status code indication may indicate a partial success of the association of the STA MLD 210 on the first link. In various examples, upon permitting partial association of the STA MLD 210 on the first link, the first AP MLD 204 may also complete an execution of a Four-Way Handshake (FWHS) protocol with the STA MLD 210 on the first link without providing the traffic access.

In many further embodiments, if the STA MLD 210 is not compatible for partial association, the first AP MLD 204 may be configured to reject the association of the STA MLD 210 on the first link. Upon rejecting the association of the STA MLD 210 on the first link, the first AP MLD 204 may generate a second status code indication, e.g., a rejection status. In an example, the second status code indication may indicate that the association of the STA MLD 210 is rejected with at least one Basic Service Set (BSS) transition suggestion/recommendation.

In further additional embodiments, upon generating the first status code indication, the first AP MLD 204 may further determine one or more links supported by the first AP MLD 204, for example, by the second radio 212B and/or the third radio 212C, that are available for complete association of the STA MLD 210. In various examples, the first AP MLD 204 may determine the one or more links that are available for the association of the STA MLD 210 based on the parameters of the one or more links. Upon determining the one or more links, the first AP MLD 204 may generate a link recommendation indication that recommends a set of second links for the association of the STA MLD 210. In various examples, the set of second links may include the determined links supported by the second radio 212B and/or the third radio 212C that are available for complete association of the STA MLD 210. In an example, the link recommendation indication may include one or more link identifiers corresponding to the set of second links.

The first AP MLD 204 may then transmit a connection management response to the STA MLD 210 for the connection management request. In an example, the connection management response may indicate that the association of the STA MLD 210 resulted in partial success on the first link, while association of the STA MLD 210 resulted in success on the set of second links (at the time instance T=T₁). In various examples, the connection management response may correspond to an association response (or a (Re)association response) including the first status code indication for partial success on the first link, a pending link indication for the partial availability of the first link, and/or the link recommendation indication for success of association on the set of second links. In some more examples, the connection management response may correspond to a response in a second authentication frame. In further examples, the connection management response may correspond to a Neighbor Report response, a link reconfiguration response, a BTM request, a frame transfer response frame, or the like.

In still further embodiments, upon receiving the connection management response, the STA MLD 210 may obtain the first status code indication, the pending link indication, and the link recommendation indication included in the connection management response. Based on the link recommendation indication, the STA MLD 210 may determine if association on the set of second links is acceptable or not. If the association on the set of second links is acceptable, the STA MLD 210 may start exchanging network traffic with the first AP MLD 204 via the set of second links, while also waiting for the first link to become available.

In still yet further embodiments, prior to transmitting the connection management response, the first AP MLD 204 may be configured to remove one or more Traffic Identifiers (TIDs) of the STA MLD 210 on the first link based on the determination that the first link is partially available. In various examples, to remove the TIDs, the first AP MLD 204 may be configured to generate a TID-To-Link Mapping (TTLM) indication. In an example, the TTLM indication may indicate a mapping of a preset TID value to the first link, where the preset TID value may be “0” to indicate traffic blocked or traffic access denied. For instance, the TTLM indication may indicate the removal of the TIDs of the STA MLD 210 on the first link. The first AP MLD 204 may also include the generated TTLM indication, along with the first status code indication, the pending link indication, and the link recommendation indication, in the connection management response transmitted to the STA MLD 210.

In more embodiments, prior to transmitting the connection management response, the first AP MLD 204 may further designate a traffic blocked status to the first link for the STA MLD 210 based on the determination that the first link is partially available. In such a scenario, the TTLM indication included in the connection management response may further indicate the traffic blocked status of the first link for the STA MLD 210.

In still yet more embodiments, upon permitting the partial association of the STA MLD 210 on the first link without providing the traffic access, the first AP MLD 204 may be configured to compile a waiting list of STA MLDs for the first link to include the STA MLD 210 that is waiting for the first link to become available. Specifically, the waiting list of STA MLDs may be compiled to include an identifier of the STA MLD 210. In various examples, the waiting list of STA MLDs may include one or more identifiers of one or more STA MLDs that are waiting for the first link to become available. The first AP MLD 204 may further determine, at one or more later time instances, whether the first link has become available. The first AP MLD 204 may determine whether the first link has become available or not based on the parameters of the first link. For example, if the first link is still partially available, the first AP MLD 204 may wait until the first link becomes available. In a scenario where the first link becomes available, the first AP MLD 204 may be configured to identify a highest prioritized STA MLD in the waiting list based on a priority order of the waiting list. In various examples, the priority order may prioritize the STA MLDs in the waiting list based on a First Come, First Serve (FCFS) order. In some more examples, the priority order may prioritize enterprise STAs over guest STAs. Upon identifying the highest prioritized STA MLD, the first AP MLD 204 may be configured to permit the traffic access for the highest prioritized STA MLD on the first link by generating a new TTLM indication for the highest prioritized STA MLD.

In an example, the highest prioritized STA MLD may be the STA MLD 210. In such a scenario, the first AP MLD 204 may be configured to map at least one TID of the STA MLD 210 to the first link to permit traffic access for the STA MLD 210 on the first link. Upon mapping the TID to the first link, the first AP MLD 204 may be configured to update the traffic blocked status of the first link to a traffic allowed status. Further, the first AP MLD 204 may generate a new TTLM indication for the STA MLD 210. In an example, the new TTLM indication may indicate the mapping of the TID of the STA MLD 210 to the first link and the traffic allowed status of the first link. Upon generating the new TTLM indication, the first AP MLD 204 may be configured to transmit, to the STA MLD 210, a new connection management response including the new TTLM indication. Thus, at a later time instance, for example, at T=T₂, partial success on the first link may change to success for the STA MLD 210. As a result, the STA MLD 210 can now exchange network traffic with the first AP MLD 204 via the first link and/or the set of second links.

In yet more embodiments, instead of allowing partial association on the first link as described above, the first AP MLD 204 can also reject the association of the STA MLD 210 on the first link upon receiving the connection management request. In such embodiments, the first AP MLD 204 may generate the second status code indication (e.g., a rejection status). In an example, the second status code indication may indicate that the association of the STA MLD 210 on the first link is rejected with at least one BSS transition suggestion. In such embodiments, the connection management response transmitted to the STA MLD 210 may include the second status code indication instead of the first status code indication, the pending link indication, and the TTLM indication.

In one or more embodiments, instead of directly permitting association on the set of second links of the first AP MLD 204, the first AP MLD 204 may provide a BSS transition suggestion to the STA MLD 210 for the set of second links. For example, if the links supported by the second radio 212B and/or the third radio 212C are available, the first AP MLD 204 may generate a first Neighbor Report element corresponding to the first AP MLD 204. The first Neighbor Report element may serve as a first link recommendation indication to the STA MLD 210 to recommend the set of second links of the first AP MLD 204 for association. The first Neighbor Report element may include a first preference indication as a field or a subfield. In an example, when the set of second links of the first AP MLD 204 are available, the first preference indication may indicate a preference value (e.g., a positive, non-zero value) for the set of second links of the first AP MLD 204. The first Neighbor Report element may further include a first Basic Multi-Link element that indicates the first AP MLD 204 and/or the set of second links of the first AP MLD 204. In other words, the first preference indication having the preference value is included in the first Neighbor Report element, and the preference value indicated by the first preference indication is for the first AP MLD 204 or the set of second links of the first AP MLD 204 indicated in the first Basic Multi-Link element within the first Neighbor Report element. The first AP MLD 204 may then include the second status code indication and the first Neighbor Report element in the connection management response transmitted to the STA MLD 210. The connection management response may include the second status code to indicate that the association of the STA MLD 210 on the first link resulted in a failure and the first Neighbor Report element to recommend the set of second links of the first AP MLD 204 to the STA MLD 210. However, if the links supported by the second radio 212B and/or the third radio 212C are unavailable, the first preference indication may indicate preference values ‘0’ for the set of second links of the first AP MLD 204 or the first AP MLD 204.

In additional embodiments, the first AP MLD 204 can also include one or more additional Neighbor Report elements for one or more other AP MLDs in the connection management response transmitted to the STA MLD 210. For example, the first AP MLD 204 may include a second Neighbor Report element corresponding to the second AP MLD 206 or a third Neighbor Report element corresponding to the third AP MLD 208 in the connection management response. In various examples, in order to generate the second Neighbor Report element and/or the third Neighbor Report element, the first AP MLD 204 may be configured to compile a neighbor AP list of the first AP MLD 204. For example, the neighbor AP list may be compiled by executing a Neighbor Discovery Protocol (NDP). In an example, the neighbor AP list may include an SSID of the network, a set of identifiers of the second AP MLD 206 and the third AP MLD 208, a set of operating frequency bands supported by the second AP MLD 206 and the third AP MLD 208, a set of link identifiers of links supported by the second AP MLD 206 and the third AP MLD 208, link information of the links supported by the second AP MLD 206 and the third AP MLD 208, or the like. For example, the link information of the links may include a number of STAs connected to each link of the links and/or a channel utilization value of each link of the links.

Upon compiling the neighbor AP list, the first AP MLD 204 may be configured to determine whether the neighbor AP list includes an excluded AP MLD that is part of an excluded BSS. As used herein, the excluded AP MLD may refer to an AP MLD whose associated links are overloaded and unavailable for accepting a new association. For example, the first AP MLD 204 may determine, based on the neighbor AP list, the second AP MLD 206 as a non-excluded AP MLD and the third AP MLD 208 as the excluded AP MLD. As used herein, the non-excluded AP MLD may refer to an AP MLD with at least one available link for accepting a new association.

Upon determining the second AP MLD 206 as the non-excluded AP MLD, the first AP MLD 204 may generate the second Neighbor Report element as a second link recommendation indication for the association of the STA MLD 210. For example, the second Neighbor Report element may recommend an additional set of second links for the association of the STA MLD 210. The additional set of second links may include one or more available links supported by the second AP MLD 206. The second Neighbor Report element may include a second Basic Multi-Link element that indicates the second AP MLD 206. The second Neighbor Report element may further include a second preference indication as a field or subfield. The second preference indication may indicate preference values for the one or more links of the second AP MLD 206 or a preference value for the second AP MLD 206 that is indicated in the second Basic Multi-Link element within the second Neighbor Report element. Since the second AP MLD 206 is a non-excluded AP MLD and has available links, the preference value(s) may be positive, non-zero value(s). Conversely, if any specific link of the second AP MLD 206 is unavailable for association, a preference value for such a link can be set to ‘0’ to indicate the STA MLD 210 to not attempt to connect to that link. Thus, the first AP MLD 204 may include the second Neighbor Report element in the connection management response transmitted to the STA MLD 210.

Upon determining the third AP MLD 208 as the excluded AP MLD, the first AP MLD 204 may generate the third Neighbor Report element as a third link recommendation indication for the association of the STA MLD 210. In an example, the third Neighbor Report element may include a third Basic Multi-Link element that indicates the third AP MLD 208 or one or more links of the third AP MLD 208 that are a part of the excluded BSS. The third Neighbor Report element may further include a third preference indication as a field or subfield. The third preference indication may indicate a preference value of ‘0’ for the third AP MLD 208 or the one or more links of the third AP MLD 208 that are indicated by the third Basic Multi-Link element within the third Neighbor Report element. Upon generating the third Neighbor Report element, the first AP MLD 204 may include the third Neighbor Report element in the connection management response transmitted to the STA MLD 210. Here, the third Neighbor Report element with the preference value of ‘0’ for the third AP MLD 208 may indicate to the STA MLD 210 not to attempt to connect to (or associate with) the third AP MLD 208.

In this way, the MLO management logic 220 may configure the first AP MLD 204 to provide at least one link recommendation indication indicating the set of second links of the first AP MLD 204 and/or the second AP MLD 206 for the association of the STA MLD 210, if the first link of the first AP MLD 204 is unavailable. However, if the first link of the first AP MLD 204 is partially available, the MLO management logic 220 may configure the first AP MLD 204 to permit partial association with the first link, while also providing at least one link recommendation indication indicating the set of second links of the first AP MLD 204 and/or the second AP MLD 206 for the association of the STA MLD 210. Accordingly, if the first link of the first AP MLD 204 is unavailable or partially available, the MLO management logic 220 may enable the first AP MLD 204 to suppress connection failure(s) related to the STA MLD 210, which in turn enables the first AP MLD 204 to improve latency and/or improve user experience. Further, the MLO management logic 220 may enable the STA MLD 210 to utilize the set of second links for the association if the first link is unavailable or partially available. As a result, the MLO management logic 220 may enable a wireless network including the set of AP MLDs 204-206 and the STA MLD 210 to fully leverage the available spectrum utilized by the set of APs 204-206.

In one or more embodiments, an AP MLD (for example, any of the first through third AP MLDs 204, 206, 208) may receive a connection management request from an STA MLD (e.g., the STA MLD 202) requesting association or (Re)association to a first link of the AP MLD. If the AP MLD determines that the first link requested by the STA MLD is unavailable, the AP MLD may determine whether other links of the AP MLD are available for partial association or complete association. In a scenario where the AP MLD determines that there is at least one second link available on which the STA MLD can associate successfully or partially, the AP MLD may transmit a connection management response to the STA MLD. The connection management response may indicate to the STA MLD that the connection is successful or partially successful on the at least one second link instead of the requested first link, and the that the STA MLD can operate on the at least one second link. In other words, instead of providing a rejection status for the requested first link in the connection management response, the AP MLD can provide a connection successful status for the least one second link and one or more details of the least one second link in the connection management response. In addition, the AP MLD can further recommend one or more other second links, belonging to the same AP MLD or a different AP MLD, that the STA MLD can connect to in the connection management response.

Although a specific embodiment of the network environment 202 is described above with respect to FIG. 2, any of a variety of systems and/or processes may be utilized in accordance with embodiments of the disclosure. For example, the MLO Management logic 220 may be embodied within the second AP MLD 206 and/or the third AP MLD 208. The elements depicted in FIG. 2 may also be interchangeable with other elements of FIG. 1 and FIGS. 3-11 as required to realize a particularly desired embodiment.

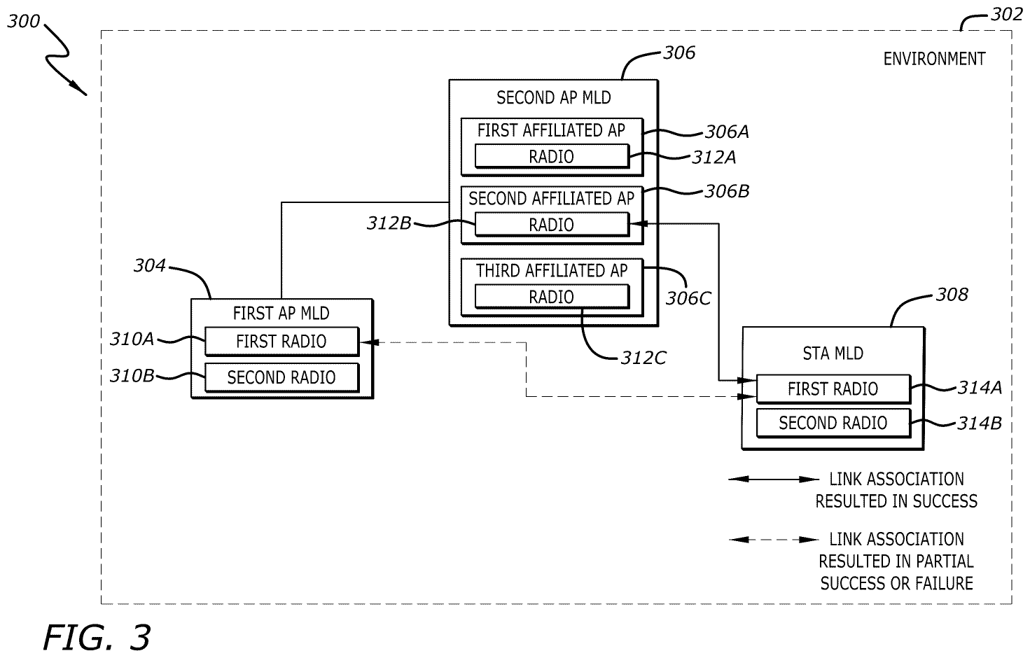

Referring to FIG. 3, a conceptual block diagram 300 of a network environment 302 for link recommendation in accordance with various embodiments of the disclosure is shown. In the embodiments shown in FIG. 3, the network environment 302 may include a set of AP MLDs 304 and 306 and an STA MLD 308. The set of AP MLDs 304 and 306 may include a first AP MLD 304 and a second AP MLD 306. The first AP MLD 304 may correspond to a single AP that includes a set of radios 310A and 310B for supporting the MLO. The second AP MLD 306 may correspond to a set of affiliated APs 306A-306C that collectively supports the MLO. The set of affiliated APs 306A-306C may include a first affiliated AP 306A, a second affiliated AP 306B, and a third affiliated AP 306C. Each affiliated AP of the set of affiliated APs 306A-306C may include at least one radio. For example, the set of affiliated APs 306A-306C may include a set of radios 312A-312C, respectively. The STA MLD 308 may include a single radio for supporting MLO or may include a plurality of radios such as 314A and 314B to support MLO.

In a variety of embodiments, each of the set of AP MLDs 304 and 306 may execute a Neighbor Discovery Protocol (NDP) to compile its corresponding neighbor AP list. For example, the first AP MLD 304 may execute the NDP with the second AP MLD 306 to compile a neighbor AP list of the first AP MLD 304. In an example, the neighbor AP list may include an SSID of the network, a set of Basic Service Set Identifiers (BSSIDs) of the set of affiliated APs 306A-306C, link information of the set of affiliated APs 306A-306C, or the like. In various examples, the set of BSSIDs may include a set of MAC addresses of the set of radios 312A-312C. In numerous examples, the link information of an affiliated AP of the set of affiliated APs 306A-306C may include at least one link identifier of at least one link of the affiliated AP, a number of STAs connected to the link, a channel utilization value of the link, or the like.

In many embodiments, when the STA MLD 308 is located within a geographical area serviced by the first AP MLD 304, the STA MLD 308 may be configured to receive one or more beacon frames broadcasted by the first AP MLD 304. For example, a beacon frame of the beacon frames may include an SSID of the network, an identifier of a radio of the set of radios 310A and 310B, a link identifier of the link supported by the radio, or the like. Upon receiving the beacon frames, the STA MLD 308 may be configured to transmit a connection management request to the first AP MLD 304. The connection management request may be a request for an association of the STA MLD 308 to a first link supported by the first radio 310A of the first AP MLD 304. In various examples, the connection management request may be one of an association request, a (Re)association request, a BTM query, a BTM response, a request in a first authentication frame, a link reconfiguration request, a frame transfer request frame, or a Neighbor Report request.

Upon receiving the connection management request, the first AP MLD 304 may be configured to determine whether the first link is available for the association of the STA MLD 308 based on one or more parameters of the first link. For example, the parameters of the first link may include a link configuration parameter indicating the maximum number of STAs that can connect to the first link, a link utilization parameter indicating the maximum channel utilization value, or the like. For embodiments shown in FIG. 3, the first AP MLD 304 may determine that the first link is either unavailable or partially available for the association of the STA MLD 308. In various examples, if the number of STAs connected to the first link is equal to (or greater than) the maximum number of STAs, the first AP MLD 304 may determine that the first link is unavailable for the association of the STA MLD 308. In some more examples, if the channel utilization value of the first link is equal to (or greater than) the maximum channel utilization value, the first AP MLD 304 may determine that the first link is unavailable or partially available for the association of the STA MLD 308.

In many further embodiments, upon determining that the first link is partially available, the first AP MLD 304 may permit partial association of the STA MLD 308 on the first link without providing traffic access for the STA MLD 308. Association without traffic access may refer to partial association. Upon permitting the partial association of the STA MLD 308 to the first link without providing traffic access, the first AP MLD 304 may generate a first status code indication and a pending link indication. In an example, the first status code indication may indicate a partial success of the association of the STA MLD 308 and the pending link indication may indicate the partial availability of the first link.

In many additional embodiments, upon determining that the first link is unavailable, the first AP MLD 304 may reject association of the STA MLD 308 on the first link. Upon rejecting the association of the STA MLD 308 on the first link, the first AP MLD 304 may generate a second status code indication. In an example, the second status code indication may indicate a failure of the association of the STA MLD 308 on the first link.

In further embodiments, the first AP MLD 304 may be configured to determine whether at least one link supported by the second radio 310B is available for the association of the STA MLD 308 based on the parameters of the link. For the embodiments shown in FIG. 3, the first AP MLD 304 may determine that the link supported by the second radio 310B is unavailable for the association of the STA MLD 308. In various examples, if the link supported by the second radio is overloaded (e.g., the number of STAs connected to the first link is equal to the maximum number of STAs), the first AP MLD 304 may determine that the link supported by the second radio 310B is unavailable for the association of the STA MLD 308. Upon determining that the link supported by the second radio 310B is unavailable, the first AP MLD 304 may determine whether one or more links of the second AP MLD 306 are available for the association of the STA MLD 308 based on the link information included in the neighbor AP list. For the embodiments shown in FIG. 3, the first AP MLD 304 may determine that links of the first affiliated AP 306A and the second affiliated AP 306B are available, and at least one link of the third affiliated AP 306C is unavailable.

In still further embodiments, upon determining that the links of the first affiliated AP 306A and the second affiliated AP 306B are available, the first AP MLD 304 may generate one or more link recommendation indications. In various examples, the one or more link recommendation indications may recommend a set of second links for the association of the STA MLD 308. In an example, connectivity on the set of second links may be provided by the first affiliated AP 306A and the second affiliated AP 306B of the second AP MLD 306 that is different from the first AP MLD 304.

The first AP MLD 304 may then transmit, to the STA MLD 308, a connection management response for the connection management request. In an example, the connection management response may include one of the first status code indication or the second status code indication based on the partial availability or unavailability of the first link, respectively. The connection management response may further include the pending link indication, and/or the one or more link recommendation indications.

In many additional embodiments, for providing the link recommendation indications, the first AP MLD 304 may include a plurality of Neighbor Report elements in the connection management response. For generating the plurality of Neighbor Report elements, the first AP MLD 304 may determine whether another link of the first AP MLD 304 or links of the second AP MLD 306 are available for the association of the STA MLD 308.

In an example scenario, the first AP MLD 304 may determine whether the link supported by the second radio 310B is available for the association based on the parameters of the link. For the embodiments shown in FIG. 3, the first AP MLD 304 may determine that the link supported by the second radio 310B is unavailable for the association. Upon determining that the link supported by the second radio 310B is unavailable for the association, the first AP MLD 304 may be configured to generate a first Neighbor Report element corresponding to the first AP MLD 304. The first Neighbor Report element may include a first preference indication as a field or a subfield, indicating a preference value of ‘O’ for the link supported by the second radio 310B or the first AP MLD 304. Furthermore, the first Neighbor Report element may include a first Basic Multi-Link element that indicates the link supported by the second radio 310B or the first AP MLD 304. In other words, the first preference indication in the first Neighbor Report element may indicate that the link supported by the second radio 310B or the first AP MLD 304, indicated by the first Basic Multi-Link element in the first Neighbor Report element, has the preference value ‘0’.

In still additional embodiments, the first AP MLD 304 may further determine whether the links of the second AP MLD 306 are available for the association of the STA MLD 308 based on the link information included in the neighbor AP list. For the embodiments shown in FIG. 3, the first AP MLD 304 may determine that links of the first affiliated AP 306A and the second affiliated AP 306B are available and at least one link of the third affiliated AP 306C is unavailable. Upon determining the available links and the non-available link, the first AP MLD 304 may be configured to generate a second Neighbor Report element and a third Neighbor Report element.

The second Neighbor Report element may correspond to a subset of affiliated APs 306A and 306B in the second AP MLD 306 or links supported by the subset of affiliated APs 306A and 306B in the second AP MLD 306. The second Neighbor Report element may include a preference value for the subset of affiliated APs 306A and 306B or the links supported by the subset of affiliated APs 306A and 306B in the second AP MLD 306. The second Neighbor Report element may further include a second Basic Multi-Link element to indicate the subset of affiliated APs 306A and 306. In other words, the second preference indication is included in the second Neighbor Report element, and the preference value indicated by the second preference indication is for the subset of affiliated APs 306A and 306 indicated in the second Basic Multi-Link element within the second Neighbor Report element.

The third Neighbor Report element may correspond to the third affiliated AP 306C or a link supported by the third affiliated AP 306C that is unavailable. Further, the third Neighbor Report element may include a third preference indication indicating a preference value of ‘0’ for the third affiliated AP 306C or the link supported by the third affiliated AP 306C that is unavailable. Furthermore, the third Neighbor Report element may include a third Basic Multi-Link element to indicate the third affiliated AP 306C or the link supported by the third affiliated AP 306C. In other words, the third preference indication is included in the third Neighbor Report element, and the preference value indicated by the third preference indication is for the third affiliated AP 306C or the link supported by the third affiliated AP 306C indicated in the third Basic Multi-Link element within the third Neighbor Report element. Thus, the first AP MLD 304 may include these plurality of Neighbor Report elements, along with other indications, in the connection management response transmitted to the STA MLD 308 for the connection management request.

In yet more embodiments, upon receiving the connection management response, the STA MLD 308 may be configured to determine whether the association on the requested first link is successful or not. In a scenario where the association on the requested first link resulted in a failure, the STA MLD 308 may determine the one or more link recommendation indications (e.g., the plurality of Neighbor Report elements) whose preference values are positive, non-zero. Upon determining such link recommendation indications in the connection management response, the STA MLD 308 may be configured to identify a highest preferred link recommendation indication among the one or more link recommendation indications based on the preference values. For the embodiments shown in FIG. 3, the STA MLD 308 may be configured to identify, as the highest preferred link recommendation indication, the second link recommendation indication that recommends the link of the second affiliated AP 306B with the highest preference value. Upon identifying the highest preferred link recommendation indication, the STA MLD 308 may transmit a new connection management request to the second AP MLD 306. In an example, the new connection management request may include an association request for an association of the STA MLD 308 to the link recommended in the highest preferred link recommendation indication (e.g., the link of the second affiliated AP 306B). Upon receiving the new connection management request, the second AP MLD 306 may permit the association of the STA MLD 308 on the link of the second affiliated AP 306B. Upon permitting the association of the STA MLD 308, the second AP MLD 306 may transmit a new connection management response to the STA MLD 308. In an example, the new connection management response may indicate that the association of the STA MLD 308 is successful.

In many further embodiments, the connection management response transmitted to the STA MLD 308 may include multiple Neighbor Report elements to report the same second AP MLD 306 such that each Neighbor Report element recommends a different subset of affiliated APs, with same or different preference value for each affiliated AP.

Though FIG. 3 describes an example scenario where the first AP MLD 304 provides a link recommendation indication in the connection management response, indicating the STA MLD 308 to connect to any of the set of second links of the first affiliated AP 306A and the second affiliated AP 306B in the second AP MLD 306, the scope of the disclosure is not limited to it. For example, if an affiliated AP that is a part of an AP MLD determines that a first link of the affiliated AP requested by an STA MLD in a connection management request is unavailable, the affiliated AP can provide a link recommendation indication in a connection management response to the STA MLD. The link recommendation indication may recommend a set of second links of other affiliated APs of the same AP MLD to the STA MLD for association. In other words, the set of second links provided in the connection management response can also belong to one or more other affiliated APs of the AP MLD, and may correspond to a smaller subset of links on which the AP MLD can provide connectivity.

Although a specific embodiment of the network environment 302 is described above with respect to FIG. 3, any of a variety of systems and/or processes may be utilized in accordance with embodiments of the disclosure. For example, the first AP MLD 304 may also correspond to a set of two affiliated APs that collectively supports the MLO. In an example, the set of two affiliated APs may include a first affiliated AP having the first radio 310A and a second affiliated AP having the second radio 310B. The elements depicted in FIG. 3 may also be interchangeable with other elements of FIGS. 1-2 and FIGS. 4-11 as required to realize a particularly desired embodiment.

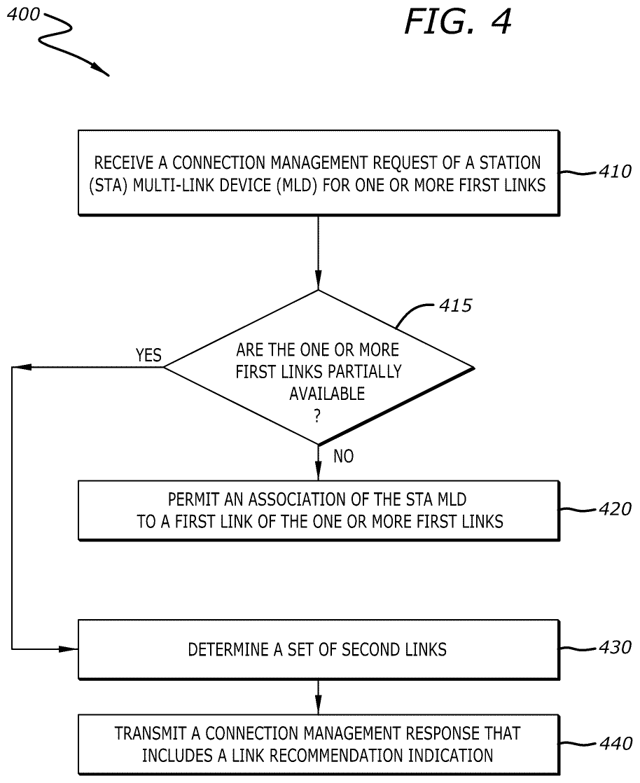

Referring to FIG. 4, a flowchart depicting a process 400 for transmitting a link recommendation indication in accordance with various embodiments of the disclosure is shown. In many embodiments, the process 400 may receive a connection management request of an STA MLD for one or more first links (block 410). In an example, the STA MLD may be a part of a wireless network that includes a WLC and/or a set of AP MLDs. For example, the set of AP MLDs may include a first AP MLD and a second AP MLD. Each AP MLD of the set of AP MLDs may correspond to either a single AP that includes multiple radios for supporting MLO, or a set of affiliated APs, each affiliated AP with at least one radio, that collectively supports the MLO. As used herein, an AP, multi-link or otherwise, may refer to a device that allows one or more STAs (e.g., the STA MLD) to connect to a network (e.g., the Internet) or other STAs. As used herein, the STA MLD may correspond to a mobile computing device that includes multiple radios or a single radio for supporting the MLO. In other words, the STA MLD can incorporate a multi-link single radio (MLSR) interface or a multi-link multiple radio (MLMR) interface for MLO. For example, the mobile computing device may include a smartphone, a tablet, a laptop/notebook, a wearable device, or the like. As used herein, the WLC may include a device that manages the set of AP MLDs to ensure efficient data routing, security, and configuration.

In many additional embodiments, an AP MLD of the set of AP MLDs may provide connectivity on the first links. For example, the first AP MLD may provide connectivity on the first links. In many further embodiments, the connection management request may be received by a network device of the wireless network. For example, the network device may include one of: the WLC, the AP MLD of the set of AP MLDs, or an affiliated AP of the set of affiliated APs. In various examples, the connection management request may include an association request, a (Re)association request, a BTM query, a BTM response, a request in a first authentication frame, a link reconfiguration request, a frame transfer request frame, or a Neighbor Report request. In an example, the connection management request may include an SSID of the network, at least one frequency band supported by the STA MLD, one or more link identifiers of the first links, or the like.

In further embodiments, the process 400 may determine whether the first links are partially available (block 415). In an example, the network device may determine whether the first links are partially available based on one or more parameters of the first links. For example, the parameters of a specific first link of the first links may include a link configuration parameter, a link utilization parameter, or the like. For instance, the link configuration parameter may indicate the maximum number of STAs that can connect to the specific first link. The link utilization parameter may indicate a maximum channel utilization value, beyond which the specific first link becomes partially available. In various examples, if the number of STAs connected to the specific first link is less than the maximum number of STAs and/or the channel utilization value of the specific first link is less than the maximum channel utilization value, the process 400 may determine that the specific first link is available. Conversely, if the number of STAs connected to the specific first link is not less than the maximum number of STAs and/or the channel utilization value of the specific first link is not less than the maximum channel utilization value, the process 400 may determine that the specific first link is partially available.

In still further embodiments, if the first links are available, the process 400 may permit the association of the STA MLD to a first link of the first links (block 420). In an example, the network device may permit the association of the STA MLD to the first link. In order to permit the association of the STA MLD to the first link, the process 400 may select an optimal first link among the first links and permit the association of the STA MLD to the optimal first link. In various examples, the first link with the highest Received Signal Strength Indicator (RSSI) among the first links may be selected as the optimal first link. In some more examples, the first link with the lowest channel utilization value among the first links may be selected as the optimal first link.

In more embodiments, if the first links are partially available, the process 400 may determine a set of second links (block 430). In an example, the network device may determine the set of second links of the set of AP MLDs. In numerous examples, the set of second links may include one or more links that are available for the association of the STA MLD. In still more embodiments, the process 400 may determine the one or more links that are available for the association based on the parameters of the one or more links. In an example, the one or more links may include a link of the first AP MLD and/or a link of the second AP MLD.

In additional embodiments, the process 400 may transmit a connection management response that includes the link recommendation indication (block 440). In an example, the network device may transmit the connection management response including the link recommendation indication. Examples of the connection management response may include an association response, a (Re)association response, a Neighbor Report response, a link reconfiguration response, a BTM request, a frame transfer response frame, or a response in a second authentication frame. The link recommendation indication may be provided one or more Neighbor Report elements included in the connection management response.

In yet more embodiments, if the first links are partially available, the process 400 may permit partial association of the STA MLD to the first links without providing traffic access for the STA MLD on the first links. In such an embodiment, the connection management response may further include a first status code indication. In an example, the first status code indication may indicate a partial success of the association of the STA MLD on the first links with a TTLM mapping indicating traffic blocked on the first links.

Although a specific embodiment of the process 400 for carrying out the various steps, processes, methods, and operations described herein is discussed with respect to FIG. 4, any of a variety of systems and/or processes may be utilized in accordance with embodiments of the disclosure. For example, upon permitting the association of the STA MLD (block 420), the process 400 may further transmit a connection management response indicating that the association of the STA MLD is successful. In several more embodiments, if the first links are unavailable, the process 400 may reject association of the STA MLD on the first links. In such an embodiment, the connection management response may further include a second status code indication. In an example, the second status code indication may indicate that the association of the STA MLD on the first links is rejected with at least one BSS transition suggestion. The elements depicted in FIG. 4 may also be interchangeable with other elements of FIGS. 1-3 and 5-11 as required to realize a particularly desired embodiment.

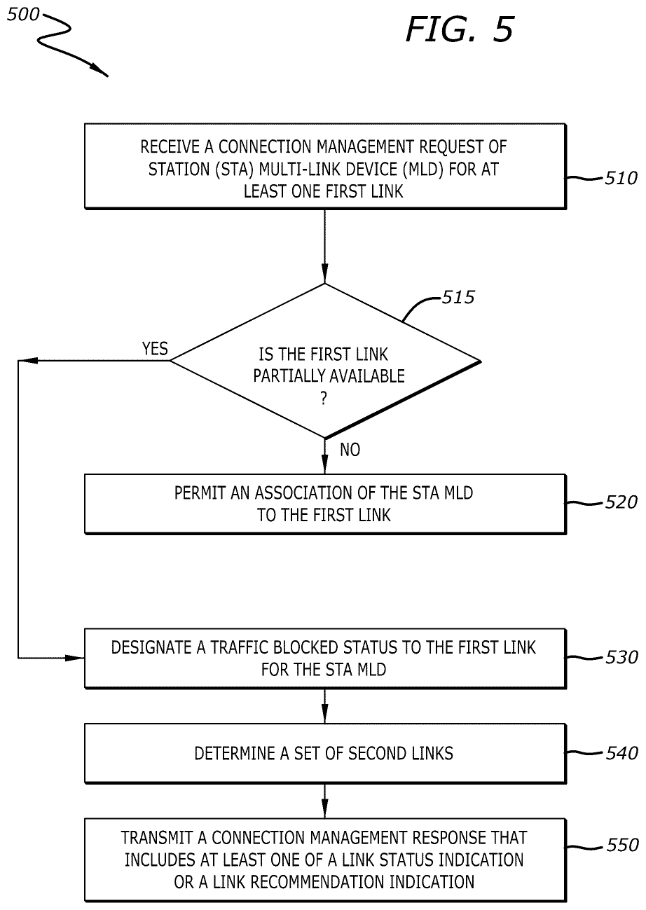

Referring to FIG. 5, a flowchart depicting a process 500 for transmitting at least one of a link recommendation indication or a link status indication in accordance with various embodiments of the disclosure is shown. In many embodiments, the process 500 may receive a connection management request of an STA MLD for at least one first link (block 510). In an example, the connection management request may be received by a network device of a wireless network. In various examples, the wireless network may include the STA MLD, a set of AP MLDs to which the STA MLD can be connected, and/or a WLC or a cloud service that controls the set of AP MLDs. The network device may include one of: an AP MLD of the set of AP MLDs or the WLC. The set of AP MLDs may include a first AP MLD and a second AP MLD. In an example, the first AP MLD may provide connectivity on the at least one first link. Examples of the connection management request may include an association request, a (Re)association request, a BTM query, a BTM response, a request in a first authentication frame, a link reconfiguration request, a frame transfer request frame, or a Neighbor Report request.

In many further embodiments, the process 500 may determine whether the first link is partially available (block 515). In an example, the network device may determine whether the first link is partially available based on one or more parameters of the first link. For example, the parameters of the first link may include a link configuration parameter, a link utilization parameter, or the like. For instance, the link configuration parameter may indicate the maximum number of STAs that can connect to the first link. The link utilization parameter may indicate a maximum channel utilization value, beyond which the first link becomes partially available. In various examples, if the number of STAs connected to the first link is less than the maximum number of STAs and/or the channel utilization value of the first link is less than the maximum channel utilization value, the process 500 may determine that the first link is available. Conversely, if the number of STAs connected to the first link is not less than the maximum number of STAs and/or the channel utilization value of the first link is not less than the maximum channel utilization value, the process 500 may determine that the first link is partially available.

In further embodiments, if the first link is available, the process 500 may permit the association of the STA MLD to the first link (block 520). In an example, the network device may permit the association of the STA MLD to the first link. In various examples, upon permitting the association of the STA MLD, the process 500 may transmit a connection management response to the STA MLD. For example, the connection management response may indicate that the association of the STA MLD is successful.

In still further embodiments, if the first link is partially available, the process 500 may designate a traffic blocked status to the first link for the STA MLD (block 530). In an example, the network device may designate the traffic blocked status to the first link for the STA MLD. In various examples, the traffic blocked status may be designated to the first link in order to block traffic access for the STA MLD on the first link. In some more examples, the traffic blocked status may be designated to the first link in order to permit the partial association of the STA MLD to the first link without providing the traffic access. Upon designating the traffic blocked status, the process 500 may be configured to generate a link status indication, for example, a TTLM indication. In an example, the link status indication may indicate the traffic blocked status of the first link and a mapping of a preset TID value to the first link. The preset TID value may be “0” to indicate traffic blocked or traffic access denied.

In more embodiments, the process 500 may determine a set of second links (block 540). In an example, the network device may determine the set of second links of the set of AP MLDs. In numerous examples, the set of second links may include one or more links that are available for the association of the STA MLD. In still more embodiments, the process 500 may determine the one or more links that are available for the association based on the parameters of the one or more links. In an example, the one or more links may include a link of the first AP MLD and/or a link of the second AP MLD. Upon determining the set of second links, the process 500 may generate one or more link recommendation indications that recommend the set of second links for the association of the STA MLD. In an example, the link recommendation indication may include one or more link identifiers corresponding to the set of second links.

In yet more embodiments, the process 500 may transmit a connection management response that includes at least one of the link status indication or the link recommendation indication (block 550). In an example, the network device may transmit, to the STA MLD, the connection management response including the link status indication and/or the link recommendation indication. In various examples, the connection management response may correspond to an association response, a (Re)association response, a Neighbor Report response, a link reconfiguration response, a BTM request, a frame transfer response frame, or a response in a second authentication frame.

Although a specific embodiment of the process 500 for carrying out the various steps, processes, methods, and operations described herein is discussed with respect to FIG. 5, any of a variety of systems and/or processes may be utilized in accordance with embodiments of the disclosure. For example, the process 500 may generate a status code indication indicating a partial success of the association of the STA MLD. Further, the process 500 may transmit the connection management response including the status code indication, the link status indication, and/or the link recommendation indication. The elements depicted in FIG. 5 may also be interchangeable with other elements of FIGS. 1-4 and 6-11 as required to realize a particularly desired embodiment.

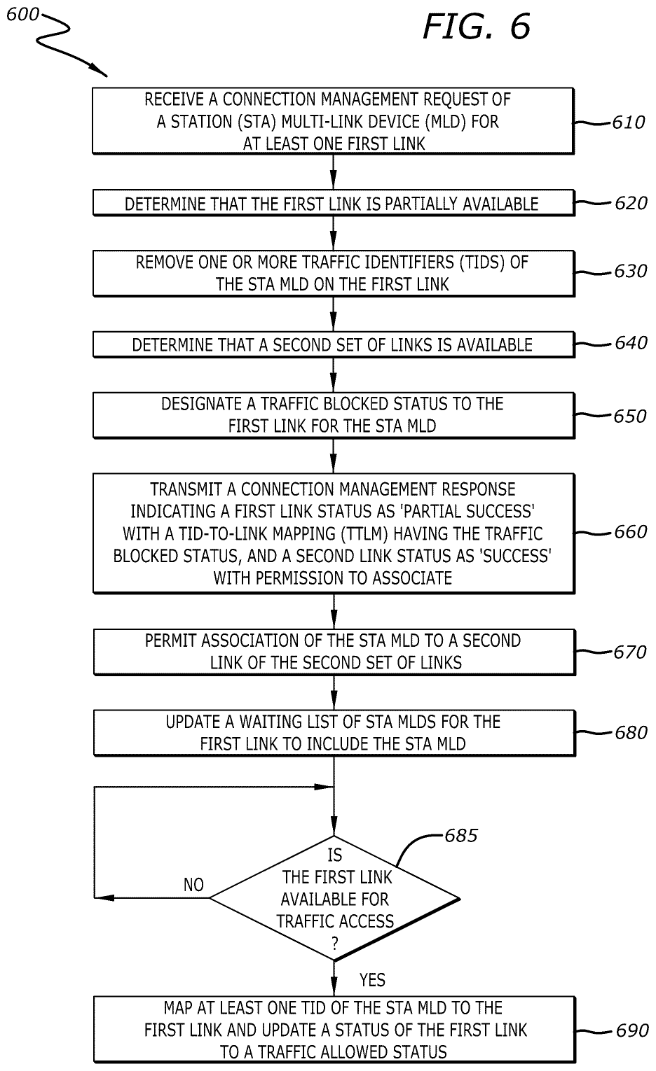

Referring to FIG. 6, a flowchart depicting a process 600 for managing partial success on a requested link in accordance with various embodiments of the disclosure is shown. In many embodiments, the process 600 may receive a connection management request of an STA MLD for at least one first link (block 610). In an example, the connection management request may be received by a network device of a wireless network. In various examples, the wireless network may include the STA MLD, a set of AP MLDs to which the STA MLD can be connected, and/or a WLC that controls the set of AP MLDs. The network device may include one of: an AP MLD of the set of AP MLDs or the WLC. The set of AP MLDs may include a first AP MLD and a second AP MLD. In an example, the first AP MLD may provide connectivity on the at least one first link. In numerous examples, the connection management request may include an association request, a (Re)association request, a BTM query, a BTM response, a request in a first authentication frame, a link reconfiguration request, a frame transfer request frame, or a Neighbor Report request.

In many further embodiments, the process 600 may determine that the first link is partially available (block 620). In an example, the network device may determine that the first link is partially available for the association of the STA MLD. In various examples, the process 600 may determine that the first link is partially available if a number of STAs connected to the first link is equal to (or greater than) a maximum number of STAs. In some more examples, the process 600 may determine that the first link is partially available if a channel utilization value of the first link is equal to (or greater than) a maximum channel utilization value.

In further embodiments, the process 600 may remove one or more TIDs of the STA MLD on the first link (block 630). In an example, the network device may remove the TIDs of the STA MLD on the first link. In various examples, the process 600 may remove the TIDs for the STA MLD on the first link in order to block traffic access for the STA MLD on the first link. In some more examples, the process 600 may remove the TIDs for the STA MLD on the first link in order to permit the association of the STA MLD to the first link without providing the traffic access for the STA MLD on the first link. Upon removing the TIDs, the process 600 may be configured to generate a first TTLM indication. In an example, the first TTLM indication may indicate a mapping of a preset TID value to the first link. In numerous examples, the preset TID value may be “0”.

In still further embodiments, the process 600 may determine that a set of second links are available (block 640). In an example, the network device may determine the set of second links of the network device is available. In numerous examples, the set of second links may include one or more links that are available for the association of the STA MLD. In still more embodiments, the process 600 may determine the one or more links that are available for the association based on the parameters of the one or more links. In an example, the one or more links may include at least one second link, different from the first link, of the network device.

In further additional embodiments, the process 600 may designate a traffic blocked status to the first link for the STA MLD (block 650). Upon removing the TIDs of the STA MLD from the first link, the process 600 may designate the traffic blocked status to the first link to indicate that the traffic access is blocked for the STA MLD on the first link. In an example, the traffic blocked status may be indicated in the first TTLM indication.

In still yet further embodiments, the process 600 may transmit a connection management response indicating a first link status as ‘partial success’ with a TTLM having the ‘traffic blocked status’, and a second link status as ‘success’ with permission to associate (block 660). In various examples, the connection management response may correspond to an association response, a (Re)association response, a Neighbor Report response, a link reconfiguration response, a BTM request, a frame transfer response frame, or a response in a second authentication frame. In an example, the first link status may be indicated by a first status code included in the connection management response and the second link status may be indicated as a link recommendation indication in the connection management response.

In further embodiments, the process 600 may permit association of the STA MLD to a second link of the set of second links (block 670). For example, the network device may permit association of the STA MLD to the second link of the set of second links. Based on the permitted association, the STA MLD may exchange network traffic with the network device on the second link.

In more embodiments, the process 600 may update a waiting list of STA MLDs for the first link to include the STA MLD (block 680). In an example, the process 600 may have compiled the waiting list for the first link to include those STA MLDs that are waiting for the first link to become available. Once the STA MLD is allowed partial association on the first link, the process 600 may update the compiled waiting list to also include the STA MLD. For example, the process 600 may include an identifier (e.g., a MAC address) of the STA MLD in the compiled waiting list.

In still more embodiments, the process 600 may determine whether the first link is available for traffic access (block 685). In an example, the network device may determine whether the first link is available for the traffic access. In various examples, the availability of the first link may be determined based on the parameters of the first link. For example, the parameters of the first link may include a link configuration parameter, a link utilization parameter, or the like. For instance, the link configuration parameter may indicate the maximum number of STAs that can connect to the first link. The link utilization parameter may indicate a maximum channel utilization value, beyond which the first link becomes partially available. If the first link is not available for traffic access, the process 600 may continue to check till the first link becomes available for traffic access (block 685).

However, in one or more embodiments, if the first link becomes available for traffic access, the process 600 may map at least one TID of the STA MLD to the first link and update a status of the first link to a traffic allowed status (block 690). In an example, the network device may map the TID of the STA MLD to the first link. In various examples, the process 600 may map the TID to the first link in order to allow the traffic access for the STA MLD on the first link. Upon mapping the TID, the process 600 may generate a second TTLM indication. In an example, the second TTLM indication may indicate the mapping of the TID to the first link and also indicate the traffic allowed status of the first link. In various examples, the status of the first link may be updated to the traffic allowed status in order to permit the association of the STA MLD to the first link with the traffic access.

Although a specific embodiment of the process 600 for carrying out the various steps, processes, methods, and operations described herein is discussed with respect to FIG. 6, any of a variety of systems and/or processes may be utilized in accordance with embodiments of the disclosure. For example, upon updating the status of the first link, the process 600 may generate a link status indication indicating the traffic allowed status of the first link. Further, the process 600 may transmit another connection management response including the link status indication and/or another TTLM indication. The elements depicted in FIG. 6 may also be interchangeable with other elements of FIGS. 1-5 and 7-11 as required to realize a particularly desired embodiment.

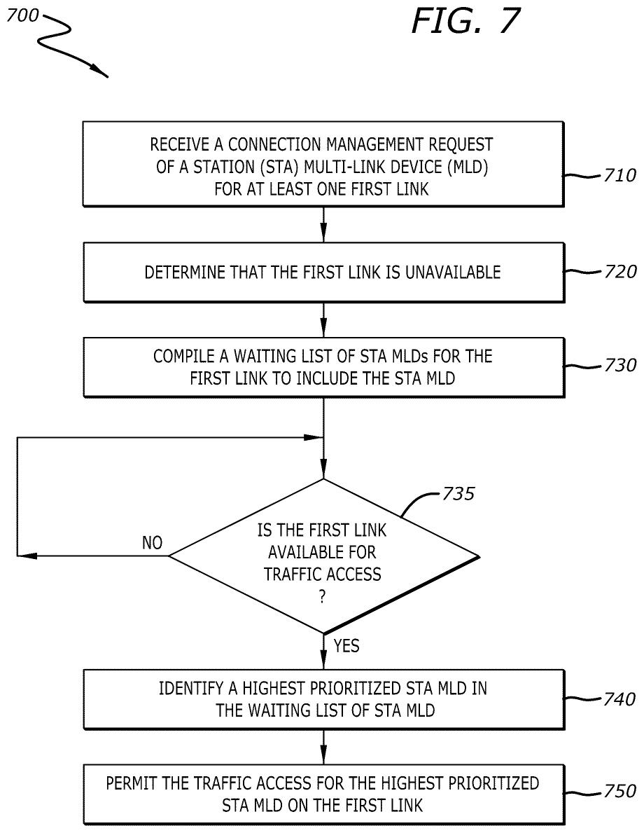

Referring to FIG. 7, a flowchart depicting a process 700 for permitting traffic access in accordance with various embodiments of the disclosure is shown. In many embodiments, the process 700 may receive a connection management request of an STA MLD for at least one first link (block 710). In an example, the connection management request may be received by a network device of a wireless network. In various examples, the wireless network may include the STA MLD, a set of AP MLDs to which the STA MLD can be connected, and/or a WLC that controls the set of AP MLDs. The network device may include one of: an AP MLD of the set of AP MLDs or the WLC. The set of AP MLDs may include a first AP MLD and a second AP MLD. In an example, the first AP MLD may provide connectivity on the at least one first link. In an example, the connection management request may include an SSID of the network, at least one frequency band supported by the STA MLD, at least one link identifier of the first link, or the like.

In many further embodiments, the process 700 may determine that the first link is partially available (block 720). In an example, the network device may determine that the first link is unavailable for successful association, but is partially available for partial association of the STA MLD. In various examples, the process 700 may determine that the first link is unavailable based on one or more parameters of the first link. Upon determining that the first link is partially available, the process 700 may permit partial association of the STA MLD to the first link without providing traffic access for the STA MLD on the first link. In further embodiments, to permit the partial association of the STA MLD without providing the traffic access, the process 700 may remove one or more TIDs for the STA MLD on the first link. In still further embodiments, to permit the partial association of the STA MLD without providing the traffic access, the process 700 may designate a traffic blocked status to the first link for the STA MLD.

In more embodiments, the process 700 may compile a waiting list of STA MLDs for the first link to include the STA MLD (block 730). In an example, the network device may compile the waiting list of STA MLDs for the first link to include the STA MLD that is waiting for the first link to become available. Specifically, the waiting list of STA MLDs may be compiled to include an identifier (e.g., a MAC address) of the STA MLD. In various examples, the waiting list of STA MLDs may include one or more identifiers of one or more STA MLDs that are waiting for the first link to become available.

In still more embodiments, the process 700 may determine whether the first link is available for the traffic access (block 735). In an example, the network device may determine whether the first link is available for the traffic access. In various examples, the availability of the first link may be determined based on the parameters of the first link. For example, the parameters of the first link may include a link configuration parameter, a link utilization parameter, or the like. For instance, the link configuration parameter may indicate the maximum number of STAs that can connect to the first link. The link utilization parameter may indicate a maximum channel utilization value, beyond which the first link becomes partially available.

In yet more embodiments, if a number of STAs connected to the first link is less than the maximum number of STAs and/or a channel utilization value of the first link is less than the maximum channel utilization value, the process 700 may determine that the first link is available. Conversely, if the number of STAs connected to the first link is not less than the maximum number of STAs and/or the channel utilization value of the first link is not less than the maximum channel utilization value, the process 700 may determine that the first link is partially available. In several more embodiments, if the first link is still partially available, the process 700 may wait until the first link becomes available by iteratively determining, at specific intervals, whether the first link is available for the traffic access (block 735).

In additional embodiments, if the first link is available for the traffic access, the process 700 may identify a highest prioritized STA MLD in the waiting list of STA MLDs (block 740). In an example, the network device may identify the highest prioritized STA MLD in the waiting list. In various examples, the process 700 may identify the highest prioritized STA MLD in the waiting list based on a priority order of the waiting list. In numerous examples, the priority order may prioritize the STA MLDs included in the waiting list based on a First Come, First Serve (FCFS) order. In numerous additional examples, the priority order may prioritize an enterprise STA MLD over a guest STA MLD.

In still additional embodiments, the process 700 may permit the traffic access for the highest prioritized STA MLD on the first link (block 750). In an example, the network device may permit the traffic access for the highest prioritized STA MLD on the first link. In still yet additional embodiments, to permit the traffic access for the highest prioritized STA MLD on the first link, the process 700 may map at least one TID to the first link for the highest prioritized STA MLD. In further additional embodiments, to permit the traffic access for the highest prioritized STA MLD on the first link, the process 700 may update a status of the first link to indicate a traffic allowed status. Upon permitting the traffic access for the highest prioritized STA MLD, the process 700 may transmit, to the highest prioritized STA MLD, a connection management response indicating the mapping of the TID to the first link for the highest prioritized STA MLD and/or the traffic allowed status of the first link for the highest prioritized STA MLD.

Although a specific embodiment of the process 700 for carrying out the various steps, processes, methods, and operations described herein is discussed with respect to FIG. 7, any of a variety of systems and/or processes may be utilized in accordance with embodiments of the disclosure. For example, the highest prioritized STA MLD may correspond to the STA MLD from which the connection management request was received. In an example, to permit the traffic access for the STA MLD, the process 700 may map the TID to the first link for the STA MLD and/or designate the traffic allowed status to the first link for the STA MLD. The elements depicted in FIG. 7 may also be interchangeable with other elements of FIGS. 1-6 and 8-11 as required to realize a particularly desired embodiment.

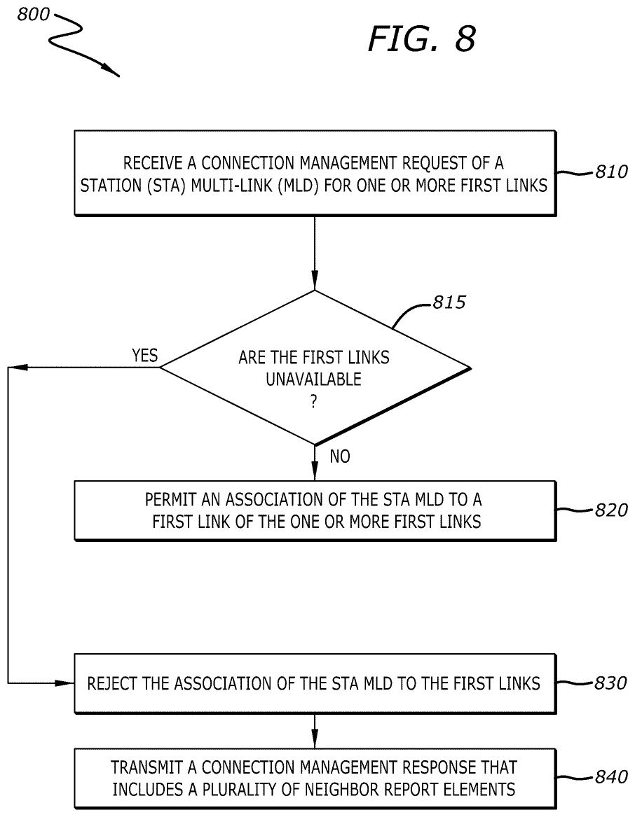

Referring to FIG. 8, a flowchart depicting a process 800 for transmitting a plurality of Neighbor Report elements in accordance with various embodiments of the disclosure is shown. In many embodiments, the process 800 may receive a connection management request of an STA MLD for one or more first links (block 810). In an example, the connection management request may be received by a network device of a wireless network. In various examples, the wireless network may include the STA MLD, a set of AP MLDs to which the STA MLD can be connected, and/or a WLC that controls the set of AP MLDs. The network device may include one of: an AP MLD of the set of AP MLDs or the WLC. The set of AP MLDs may include a first AP MLD and a second AP MLD. In an example, the first AP MLD may provide connectivity on the one or more first links. In numerous examples, the connection management request may include an association request, a (Re)association request, a BTM query, a BTM response, a request in a first authentication frame, a link reconfiguration request, a frame transfer request frame, or a Neighbor Report request. In an example, the connection management request may include an SSID of the network, at least one frequency band supported by the STA MLD, one or more link identifiers of the first links, or the like.

In many further embodiments, the process 800 may determine whether the first links are unavailable (block 815). In an example, the network device may determine whether the first links are unavailable. In various examples, the first links may be related to (or defined by) one or more parameters. For example, the parameters may indicate at least one of a maximum number of STAs or a maximum channel utilization value. For instance, if a number of STAs connected to each of the first links is less than the maximum number of STAs and/or if a channel utilization value of each of the first links is less than the maximum channel utilization value, the process 800 may determine that the first links are available. Conversely, if the number of STAs connected to each of the first links is not less than the maximum number of STAs and/or if the channel utilization value of each of the first links is not less than the maximum channel utilization value, the process 800 may determine that the first links are unavailable.

In further embodiments, if the first links are available, the process 800 may permit the association of the STA MLD to a first link of the first links (block 820). In an example, the network device may permit the association of the STA MLD to the first link. In order to permit the association of the STA MLD to the first link, the process 800 may select an optimal first link among the first links and permit the association of the STA MLD to the optimal first link. In various examples, the first link with the highest Received Signal Strength Indicator (RSSI) among the first links may be selected as the optimal first link. In some more examples, the first link with the lowest channel utilization value among the first links may be selected as the optimal first link.

In further additional embodiments, if the first links are unavailable, the process 800 may reject the association of the STA MLD to the first links (block 830). In an example, the network device may reject the association of the STA MLD to the first links. Upon rejecting the association of the STA MLD, the process 800 may determine a set of second links of the set of AP MLDs that are available for the association of the STA MLD. In an example, the process 800 may determine the set of second links based on link information of each AP MLD of the set of AP MLDs. For example, the link information of a specific AP MLD of the set of AP MLDs may include a link identifier for each link of one or more links of the specific AP MLD, a number of STAs connected to each link of the links, a channel utilization value of each link of the links, or the like. In various examples, the link information may be maintained by the network device. In some more examples, the link information may be acquired by the network device by executing an NDP with one or more AP MLDs of the set of AP MLDs. In still further embodiments, upon determining the set of second links, the process 800 may generate one or more Neighbor Report elements for the set of AP MLDs. For instance, if the set of second links includes one or more available links of the first AP MLD and/or a plurality of available links of the second AP MLD, the process 800 may generate a first Neighbor Report element for the first AP MLD and a second Neighbor Report element for the second AP MLD.

In more embodiments, the first Neighbor Report element may include a first preference indication and a first Basic Multi-Link element. The first preference indication may indicate a first preference value for the first AP MLD which is indicated by the first Basic Multi-Link element. Likewise, the second Neighbor Report element may include a second preference indication and a second Basic Multi-Link element. The second preference indication may indicate a second preference value for the second AP MLD or a subset of affiliated APs of the second AP MLD indicated by the second Basic Multi-Link element. In an example, the second Basic Multi-Link element may include link identifiers of the second AP MLD or link identifiers of the subset of affiliated APs of the second AP MLD. In many examples, the second Neighbor Report element may be generated when the first AP MLD is unable to provide connection (or association) to the STA MLD or is unable to provide association on the first links requested by the STA MLD.

In additional embodiments, the process 800 may transmit a connection management response that includes a plurality of Neighbor Report elements (block 840). In an example, the network device may transmit, to the STA MLD, the connection management response including the plurality of Neighbor Report elements such as the first Neighbor Report element and the second Neighbor Report element. In various examples, the connection management response may correspond to an association response, a (Re)association response, a Neighbor Report response, a link reconfiguration response, a BTM request, a frame transfer response frame, or a response in a second authentication frame.

Although a specific embodiment of the process 800 for carrying out the various steps, processes, methods, and operations described herein is discussed with respect to FIG. 8, any of a variety of systems and/or processes may be utilized in accordance with embodiments of the disclosure. For example, upon rejecting the association of the STA MLD, the process 800 may generate a status code indication indicating that the association of the STA MLD is rejected with at least one BSS transition suggestion. Further, the process 800 may transmit the connection management response that includes the rejected status for the first links and the plurality of Neighbor Report elements. The elements depicted in FIG. 8 may also be interchangeable with other elements of FIGS. 1-7 and 9-11 as required to realize a particularly desired embodiment.

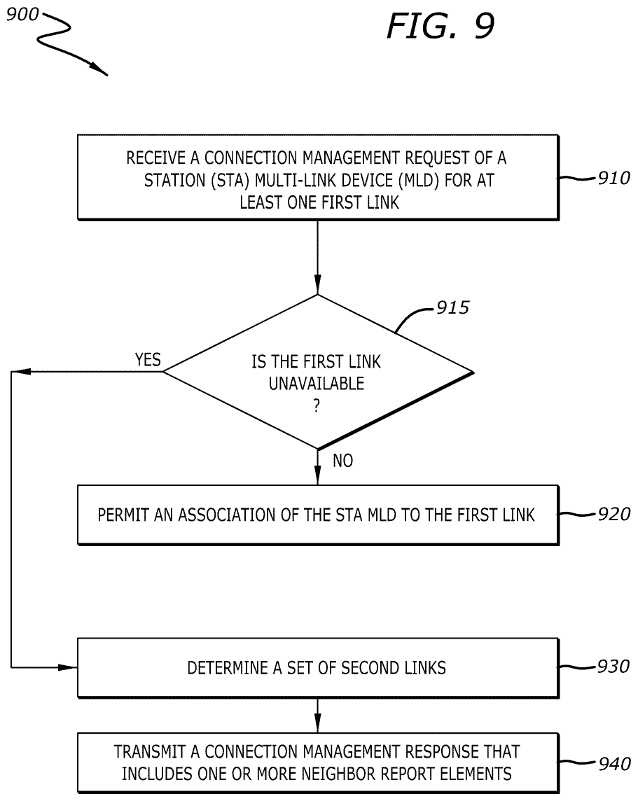

Referring to FIG. 9, a flowchart depicting a process 900 for transmitting one or more Neighbor Report elements in accordance with various embodiments of the disclosure is shown. In many embodiments, the process 900 may receive a connection management request of an STA MLD for at least one first link (block 910). In an example, the connection management request may be received by a network device of a wireless network. In various examples, the wireless network may include the STA MLD, a set of AP MLDs to which the STA MLD can be connected, and/or a WLC that controls the set of AP MLDs. The network device may include one of: an AP MLD of the set of AP MLDs or the WLC. The set of AP MLDs may include a first AP MLD, a second AP MLD, and a third AP MLD. In an example, the first AP MLD may provide connectivity on the at least one first link. Examples of the connection management request may include an association request, a (Re)association request, a BTM query, a BTM response, a request in a first authentication frame, a link reconfiguration request, a frame transfer request frame, or a Neighbor Report request.

In many further embodiments, the process 900 may determine whether the first link is unavailable (block 915). In an example, the network device may determine whether the first link is unavailable based on one or more parameters of the first link. For example, the parameters of the first link may include a link configuration parameter, a link utilization parameter, or the like. For instance, the link configuration parameter may indicate the maximum number of STAs that can connect to the first link. The link utilization parameter may indicate a maximum channel utilization value, beyond which the first link becomes unavailable. In various examples, if the number of STAs connected to the first link is less than the maximum number of STAs and/or the channel utilization value of the first link is less than the maximum channel utilization value, the process 900 may determine that the first link is available. Conversely, if the number of STAs connected to the first link is not less than the maximum number of STAs and/or the channel utilization value of the first link is not less than the maximum channel utilization value, the process 900 may determine that the first link is unavailable.

In further embodiments, if the first link is available, the process 900 may permit the association of the STA MLD to the first link (block 920). In an example, the network device may permit the association of the STA MLD to the first link. In various examples, upon permitting the association of the STA MLD, the process 900 may transmit a connection management response to the STA MLD. For example, the connection management response may indicate that the association of the STA MLD is successful.

In still further embodiments, if the first link is unavailable, the process 900 may determine a set of second links (block 930). In an example, the network device may determine the set of second links. In various examples, the process 900 may obtain link information of each AP MLD of the set of AP MLDs. For example, the link information of a specific AP MLD of the set of AP MLDs may include a link identifier for each link of one or more links of the specific AP MLD, a number of STAs connected to each link of the links, a channel utilization value of each link of the links, or the like. Further, the process 900 may determine, based on the link information, the set of second links of the set of AP MLDs that are available for the association of the STA MLD. For example, the process 900 may determine a specific link of the set of AP MLDs as a second link of the set of second links, if the number of STAs connected to the specific link is less than the maximum number of STAs allowed to connect to the specific link and/or the channel utilization value of the specific link is less than the maximum channel utilization value of the specific link.

In still yet further embodiments, upon determining the set of second links, the process 900 may generate one or more Neighbor Report elements for the set of AP MLDs. For instance, if the set of second links includes one or more available links of the second AP MLD, the process 900 may generate a first Neighbor Report element for the second AP MLD. The first Neighbor Report element may include a first preference indication and a first Basic Multi-Link element. The first preference indication may have first preference values for the one or more available links of the second AP MLD or the second AP MLD. The first Basic Multi-Link element may include one or more identifiers of the one or more available links of the second AP MLD or an identifier of the second AP MLD.

In more embodiments, the process 900 may further determine, based on the link information, whether the set of AP MLDs provides connectivity on an excluded link or the set of AP MLDs includes an excluded AP MLD. As used herein, the excluded link may refer to a link of the set of AP MLDs that is overloaded. As used herein, the excluded AP MLD may refer to an AP MLD that is a part of an excluded BSS on which association is to be avoided. In other examples, the excluded AP MLD may be a part of an excluded Extended Service Set (ESS). Upon determining that the set of AP MLDs provides connectivity on the excluded link or the set of AP MLDs includes the excluded AP MLD, the process 900 may generate one or more additional Neighbor Report elements for the excluded link and/or the excluded AP MLD. For instance, if the third AP MLD of the set of AP MLD is determined as the excluded AP MLD, the process 900 may generate a second Neighbor Report element for the third AP MLD to indicate the STA MLD not to attempt to connect to (or associate with) the third AP MLD.

In still more embodiments, the third AP MLD may correspond to a single AP that includes multiple radios. In several more embodiments, if all links supported by the multiple radios are excluded from association with the STA MLD, a second preference indication in the second Neighbor Report element may indicate a second preference value of ‘0’ for the third AP MLD indicated by a second Basic Multi-Link element within the second Neighbor Report element.

In yet more embodiments, the third AP MLD may include a set of affiliated APs. In such embodiments, if one or more links of a subset affiliated APs of the third AP MLD are excluded from association with the STA MLD, the second preference indication in the second Neighbor Report element may indicate the second preference value of ‘0’ for the subset affiliated APs indicated in the second Basic Multi-Link element within the second Neighbor Report element.

In additional embodiments, the process 900 may transmit a connection management response that includes the one or more Neighbor Report elements (block 940). In an example, the network device may transmit, to the STA MLD, the connection management response including the one or more Neighbor Report elements. In numerous examples, the connection management response may correspond to an association response, a (Re)association response, a Neighbor Report response, a link reconfiguration response, a BTM request, a frame transfer response frame, or a response in a second authentication frame. In various examples, the one or more Neighbor Report elements may include the first Neighbor Report element indicating the second AP MLD and/or the second Neighbor Report element indicating the third AP MLD that is a part of the excluded BSS.

Although a specific embodiment of the process 900 for carrying out the various steps, processes, methods, and operations described herein is discussed with respect to FIG. 9, any of a variety of systems and/or processes may be utilized in accordance with embodiments of the disclosure. For example, the connection management request can include multiple Neighbor Report elements to provide with multiple BSS transition suggestions. The elements depicted in FIG. 9 may also be interchangeable with other elements of FIGS. 1-8 and 10-11 as required to realize a particularly desired embodiment.

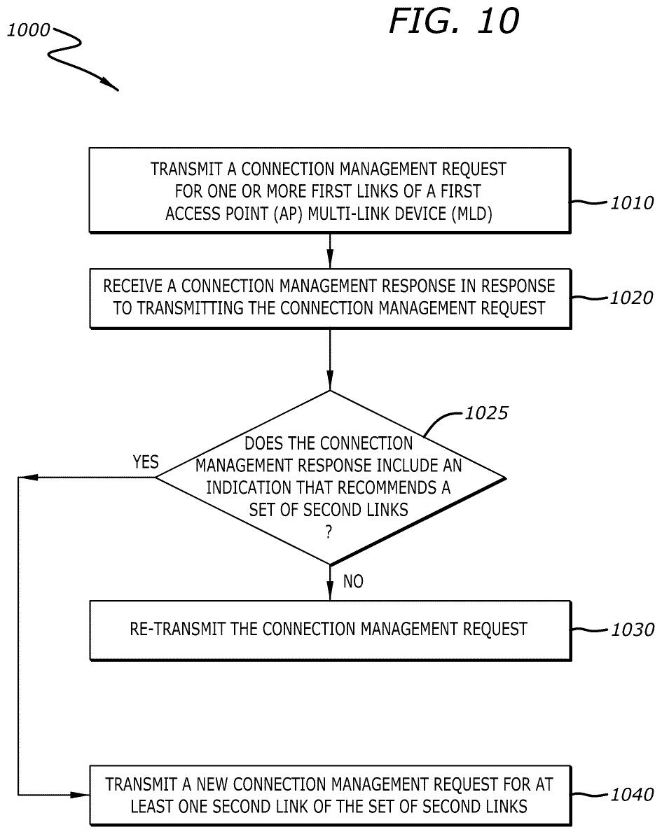

Referring to FIG. 10, a flowchart depicting a process 1000 for transmitting one or more connection management requests in accordance with various embodiments of the disclosure is shown. In many embodiments, the process 1000 may transmit a connection management request for one or more first links of a first AP MLD (block 1010). In an example, the first AP MLD may be a part of a wireless network. In various examples, the wireless network may include an STA and a set of AP MLDs to which the STA can be connected. The set of AP MLDs may include the first AP MLD. In numerous examples, the STA may transmit the connection management request for the first AP MLD of the set of AP MLDs. Examples of the connection management request may include an association request, a (Re)association request, a BTM query, a BTM response, a request in a first authentication frame, a link reconfiguration request, a frame transfer request frame, or a Neighbor Report request. In an example, the association request may include an SSID of the network, at least one frequency band supported by the STA, one or more link identifiers of the first links, or the like. In some more examples, the connection management request may include an authentication request for authentication of the STA.

In many further embodiments, upon transmitting the connection management request, the availability of the first links may be determined by the first AP MLD based on one or more parameters of the first links. For example, the parameters of a specific first link of the first links may indicate at least one of: a maximum number of STAs for the specific first link or a maximum channel utilization value for the specific first link. In various examples, if a number of STAs connected to the specific first link is less than the maximum number of STAs and/or a channel utilization value of the specific first link is less than the maximum channel utilization value, the first AP MLD may determine that the specific first link is available. Conversely, if the number of STAs connected to the specific first link is not less than the maximum number of STAs and/or the channel utilization value of the specific first link is not less than the maximum channel utilization value, the first AP MLD may determine that the specific first link is unavailable or partially available.

In further embodiments, if the first links are available, the association of the STA to a first link of the first links may be permitted by the first AP MLD. Upon permitting the association, a connection management response, indicating that the association of the STA is successful, may be transmitted by the first AP MLD. In still further embodiments, if the first links are unavailable or partially available, a set of second links of the set of AP MLDs may be determined by the first AP MLD. In various examples, the set of second links may be available for the association of the STA. Upon determining the set of second links, the association of the STA may be rejected or permitted without providing traffic access by the first AP MLD. Upon rejecting or permitting the association without providing the traffic access, a connection management response, including at least one of a status code indication or a link recommendation indication, may be transmitted by the first AP MLD. The status code indication may indicate one of a partial success of the association of the STA or the rejection of the association of the STA. The link recommendation indication may recommend the set of second links that are available for the association of the STA.

The link recommendation indication may be provided by way of one or more Neighbor Report elements included in the connection management response.

In many further embodiments, the process 1000 may receive the connection management response in response to transmitting the connection management request (block 1020). In an example, the STA may receive the connection management response. In various examples, the connection management response may correspond to an association response, a (Re)association response, a Neighbor Report response, a link reconfiguration response, a BTM request, a frame transfer response frame, or a response in a second authentication frame.

In additional embodiments, the process 1000 may determine whether the connection management response includes an indication that recommends the set of second links (block 1025). In an example, the STA may determine whether the connection management response includes the link recommendation indication. In still additional embodiments, if the connection management response does not include the link recommendation indication, the process 1000 may re-transmit the connection management request (block 1030). For example, the STA may re-transmit the connection management request. In various examples, the connection management request may be re-transmitted in order to receive a subsequent connection management response that includes the link recommendation indication.

In still yet additional embodiments, if the connection management response includes the link recommendation indication, the process 1000 may transmit a new connection management request for at least one second link of the set of second links (block 1040). In an example, the STA may transmit the new connection management request for the second link of the set of second links. In order to transmit the new connection management request for the second link, the process 1000 may determine an optimal second link among the set of second links, and transmit the new connection management request for the optimal second link. In various examples, the process 1000 may determine, as the optimal second link, a second link of the set of second links that can achieve a specific data throughput required for the STA and/or support a specific power configuration required by the STA.

Although a specific embodiment of the process 1000 for carrying out the various steps, processes, methods, and operations described herein is discussed with respect to FIG. 10, any of a variety of systems and/or processes may be utilized in accordance with embodiments of the disclosure. For example, the STA may correspond to an STA MLD that includes multiple radios for supporting MLO. The elements depicted in FIG. 10 may also be interchangeable with other elements of FIGS. 1-9 and 11 as required to realize a particularly desired embodiment.

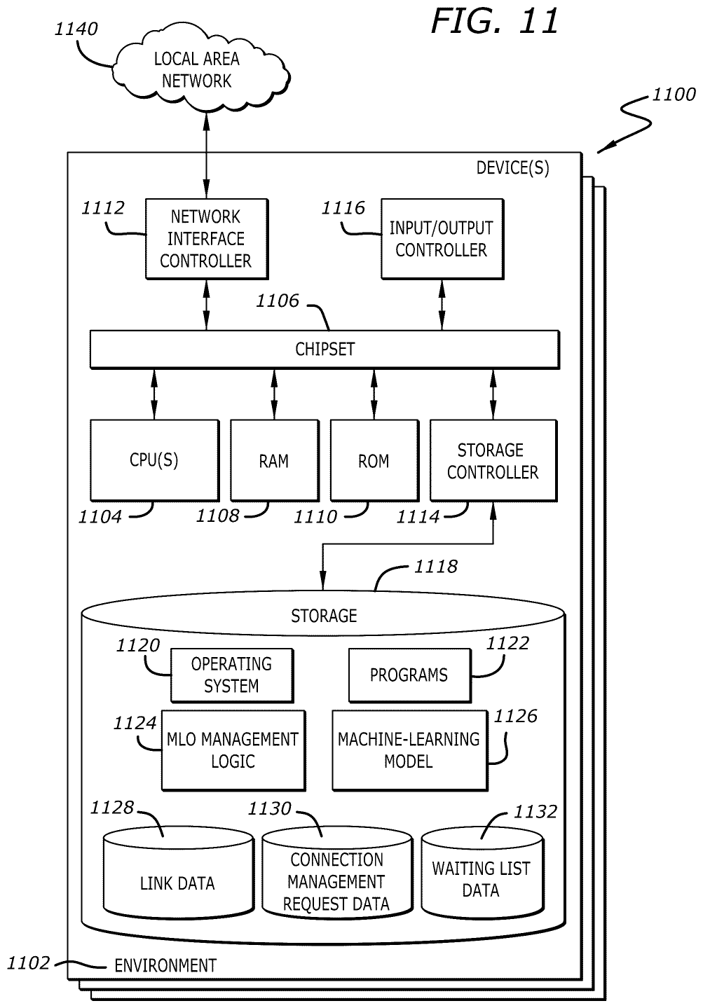

Referring to FIG. 11, a conceptual block diagram of a device 1100 suitable for configuration with an MLO management logic in accordance with various embodiments of the disclosure is shown. The embodiment of the conceptual block diagram depicted in FIG. 11 can illustrate a conventional server, computer, workstation, desktop computer, laptop, tablet, network appliance, e-reader, smartphone, or other computing device, and can be utilized to execute any of the application or logic components presented herein. The embodiment of the conceptual block diagram depicted in FIG. 11 can also illustrate an access point, a switch, or a router in accordance with various embodiments of the disclosure. The device 1100 may, in many non-limiting examples, correspond to physical devices or virtual resources described herein.

In many embodiments, the device 1100 (e.g., a WLC, an AP, or an STA) may include an environment 1102 such as a baseboard or “motherboard,” in physical embodiments that can be configured as a printed circuit board with a multitude of components or devices connected by way of a system bus or other electrical communication paths. Conceptually, in virtualized embodiments, the environment 1102 may be a virtual environment that encompasses and executes the remaining components and resources of the device 1100. In more embodiments, one or more processors 1104, such as, but not limited to, central processing units (“CPUs”) can be configured to operate in conjunction with a chipset 1106. The processor(s) 1104 can be standard programmable CPUs that perform arithmetic and logical operations necessary for the operation of the device 1100.

In a number of embodiments, the processor(s) 1104 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1106 may provide an interface between the processor(s) 1104 and the remainder of the components and devices within the environment 1102. The chipset 1106 can provide an interface to a random-access memory (“RAM”) 1108, which can be used as the main memory in the device 1100 in some embodiments. The chipset 1106 can further be configured to provide an interface to a computer-readable storage medium such as a read-only memory (“ROM”) 1110 or non-volatile RAM (“NVRAM”) for storing basic routines that can help with various tasks such as, but not limited to, starting up the device 1100 or transferring information between the various components and devices. The ROM 1110 or NVRAM can also store other application components necessary for the operation of the device 1100 in accordance with various embodiments described herein.

Additional embodiments of the device 1100 can be configured to operate in a networked environment using logical connections to remote computing devices and computer systems through a network, such as the network 1140. The chipset 1106 can include functionality for providing network connectivity through a network interface card (“NIC”) 1112, which may comprise a gigabit Ethernet adapter or similar component. The NIC 1112 can be capable of connecting the device 1100 to other devices over the network 1140. It is contemplated that multiple NICs 1112 may be present in the device 1100, connecting the device to other types of networks and remote systems.

In further embodiments, the device 1100 can be connected to a storage 1118 that provides non-volatile storage for data accessible by the device 1100. The storage 1118 can, for instance, store an operating system 1120, programs 1122, link data 1128, connection management request data 1130, and waiting list data 1132 which are described in greater detail below. The storage 1118 can be connected to the environment 1102 through a storage controller 1114 connected to the chipset 1106. In certain embodiments, the storage 1118 can consist of one or more physical storage units. The storage controller 1114 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1100 can store data within the storage 1118 by transforming the physical state of the physical storage units to reflect the information being stored. The specific transformation of physical state can depend on various factors. Examples of such factors can include, but are not limited to, the technology used to implement the physical storage units, whether the storage 1118 is characterized as primary or secondary storage, and the like.

In still more embodiments, the device 1100 can store information within the storage 1118 by issuing instructions through the storage controller 1114 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1100 can further read or access information from the storage 1118 by detecting the physical states or characteristics of one or more particular locations within the physical storage units.

In addition to the storage 1118 described above, the device 1100 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1100. In some examples, the operations performed by a cloud computing network, and or any components included therein, may be supported by one or more devices similar to device 1100. Stated otherwise, some or all of the operations performed by the cloud computing network, and or any components included therein, may be performed by one or more devices 1100 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), (electrically-erasable programmable ROM (“EEPROM”), flash memory or other solid-state memory technology, compact disc ROM (“CDROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1118 can store an operating system 1120 utilized to control the operation of the device 1100. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1118 can store other system or application programs and data utilized by the device 1100.

In many additional embodiments, the storage 1118 or other computer-readable storage media is encoded with computer-executable instructions which, when loaded into the device 1100, may transform it from a general-purpose computing system into a special-purpose computer capable of implementing the embodiments described herein. These computer-executable instructions may be stored as program 1122 (e.g., an application) and transform the device 1100 by specifying how the processor(s) 1104 can transition between states, as described above. In some embodiments, the device 1100 has access to computer-readable storage media storing computer-executable instructions which, when executed by the device 1100, perform the various processes described above with regard to FIGS. 1-10. In certain embodiments, the device 1100 can also include computer-readable storage media having instructions stored thereupon for performing any of the other computer-implemented operations described herein.

In many further embodiments, the device 1100 may include an MLO management logic 1124. The MLO management logic 1124 can be configured to perform one or more of the various steps, processes, operations, or other methods that are described above. Often, the MLO management logic 1124 can be a set of instructions stored within a non-volatile memory that, when executed by the processor(s)/controller(s) 1104 can carry out these steps, etc. In some embodiments, the MLO management logic 1124 may be a client application that resides on a network-connected device, such as, but not limited to, a server, switch, personal or mobile computing device in a single or distributed arrangement.

With the advent of MLO, STAs are allowed to connect to one or more APs by utilizing multiple frequency bands, such as 2.4 GHz, 5 GHZ, 6 GHZ, etc. This MLO functionality may enable the STAs to achieve higher data throughput, increased redundancy, and more efficient use of network resources. However, the MLO functionality may be often underutilized in practice. For example, the STAs may prioritize links operating on wider frequency bands, such as the 6 GHz band, over links operating on narrower frequency bands or different frequency bands when establishing connections. While this approach can assist in achieving higher throughput or reduced latency, it may also lead to various network performance issues. For instance, the links on the wider frequency bands may become overutilized and reach their maximum client-handling capacity sooner than the links on the narrow frequency bands, resulting in connection failures for other STAs attempting to join. To this end, in a number of embodiments, the MLO management logic 1124 may be provided to suppress the connection failures.

In numerous embodiments, when the device 1100 is configured as the WLC or the AP, the MLO management logic 1124 may be configured to receive a connection management request for one or more first links of the AP. Further, the MLO management logic 1124 may be configured to determine whether the first links are available. If the first links are available, the MLO management logic 1124 may be configured to permit the STAs to connect to the first links. Conversely, if the first links are unavailable, the MLO management logic 1124 may be configured to determine a set of second links of the AP and/or a neighbor AP of the AP that are available. Furthermore, the MLO management logic 1124 may be configured to transmit a connection management response including a link recommendation indication that recommends the set of second links to the STAs. In numerous more embodiments, when the device 1100 is configured as the STA, the MLO management logic 1124 may be configured to receive the connection management response including the link recommendation indication. Further, the MLO management logic 1124 may be configured to utilize the link recommendation indication to transmit one or more new connection management requests for one or more second links of the set of second links. Accordingly, the transmission of the connection management response including the link recommendation indication may enable the MLO management logic 1124 to suppress the connection failures for the STAs that are attempting to join.

In numerous additional embodiments, the link data 1128 may include link information of the AP and/or the neighbor AP. For example, the link information of the AP may include a link identifier for each link of one or more links of the AP, a number of STAs connected to each link of the links, a channel utilization value of each link of the links, or the like. Further, the link data 1128 may include one or more parameters of the links of the AP and/or the neighbor AP. For instance, the parameters of a specific link of the links may include a link configuration parameter, a link utilization parameter, or the like. For example, the link configuration parameter may indicate the maximum number of STAs that can connect to the specific link. The link utilization parameter may indicate a maximum channel utilization value, beyond which the specific link becomes unavailable.

In a variety of embodiments, the connection management request data 1130 may include at least one connection management request. In various examples, the connection management request may include an association request (or a (Re)association request) for an association of an STA. In an example, the association request (or the (Re)association request) may include an SSID of the network, an identifier (e.g., a MAC address) of the STA, at least one frequency band supported by the STA, one or more link identifiers for one or more first links, or the like. In some more examples, the connection management request may include an authentication frame for authentication of the STA. In numerous examples, the connection management request may include a Neighbor Report request for neighbor AP information of the neighbor AP. In numerous additional examples, the connection management request may include a link reconfiguration request, a frame transfer request, or a BTM query for requesting a neighbor AP suggestion to transition from one AP to another AP.

In various further embodiments, the waiting list data 1132 may include a waiting list of STAs. In various examples, the waiting list of STAs may include one or more identifiers of one or more STAs that are waiting for the first links to become available. In many examples, the waiting list of STAs may have a priority order. In many further examples, the priority order may prioritize the STAs in the waiting list based on a First Come, First Serve (FCFS) order. In many additional examples, the priority order may prioritize enterprise STAs over guest STAs.

In still further embodiments, the device 1100 can also include one or more input/output controllers 1116 for receiving and processing input from a number of input devices, such as a keyboard, a mouse, a touchpad, a touch screen, an electronic stylus, or other type of input device. Similarly, an input/output controller 1116 can be configured to provide output to a display, such as a computer monitor, a flat panel display, a digital projector, a printer, or other type of output device. Those skilled in the art will recognize that the device 1100 might not include all of the components shown in FIG. 11 and can include other components that are not explicitly shown in FIG. 11 or might utilize an architecture completely different than that shown in FIG. 11.

Finally, in numerous additional embodiments, data may be processed into a format usable by a machine-learning model 1126 (e.g., feature vectors), and or other pre-processing techniques. The machine-learning (“ML”) model 1126 may be any type of ML model, such as supervised models, reinforcement models, or unsupervised models. The ML model 1126 may include one or more of linear regression models, logistic regression models, decision trees, Naïve Bayes models, neural networks, k-means cluster models, random forest models, or other types of ML models 1126.

The ML model(s) 1126 can be configured to generate inferences to make predictions or draw conclusions from data. An inference can be considered the output of a process of applying a model to new data. This can occur by learning from at least the link data 1128, the connection management request data 1130, and the waiting list data 1132 and using that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1126 may be generated by human/administrator verifications or may compare predicted outcomes with actual outcomes. Further, when the device 1100 is configured as the WLC or the AP, the ML model(s) 1126 may be utilized to determine the set of second links that are available by learning the link data 1128, the connection management request data 1130, and/or the waiting list data 1132.

Although a specific embodiment for a device 1100 suitable for configuration with the MLO management logic for carrying out the various steps, processes, methods, and operations described herein is discussed with respect to FIG. 11, any of a variety of systems and/or processes may be utilized in accordance with embodiments of the disclosure. For example, the device 1100 may correspond to a mobile computing device such as a laptop (or a smartphone), or may correspond to a network device such as an AP. The elements depicted in FIG. 11 may also be interchangeable with other elements of FIGS. 1-10 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A method comprising:
establishing, by an access point (AP) multi-link device (MLD), an association with a non-AP MLD, the AP MLD comprising two or more affiliated APs, each affiliated AP operative to establish a corresponding link with an affiliated station of the non-AP MLD, wherein the establishing comprises:
receiving, on a first AP of the two or more affiliated APs of the AP MLD, an association request from the non-AP MLD, wherein the association request includes an indication of one or more requested links of the AP MLD;
determining, by the AP MLD, whether to reject the association request; and
responsive to determining by the AP MLD to reject the association request:
sending an association response using the first AP, the association response indicating a rejection of the association request and comprising a Neighbor Report element,
wherein the Neighbor Report element includes a basic multi-link element including data indicating one more suggested links of a suggested AP MLD; and
wherein the association response including the neighbor report element is operative to suggest to the non-AP MLD to attempt an association with the suggested AP MLD including at least one of the one or more suggested links.

2. The method of claim 1 wherein the one or more suggested links are a subset of the links of the suggested AP MLD.

3. The method of claim 1 wherein the suggested AP MLD is the AP MLD.

4. The method of claim 3 wherein the one or more suggested links are a subset of the links of the suggested AP MLD.

5. The method of claim 1 wherein the suggested AP is a second AP MLD neighboring the AP MLD.

6. The method of claim 1 further comprising:
responsive to accepting the association request, transmitting an association response indicating acceptance of the association and at least one of the one or more requested links.

7. The method of claim 6 further comprising maintaining the association with the non-AP MLD, the association including the one or more requested links accepted by the AP MLD.

8. The method of claim 1 wherein association response includes a second Neighbor Report element, wherein each of the Neighbor Report element and the second Neighbor Report element includes a preference value.

9. The method of claim 1 wherein the association response indicating the rejection comprises a REJECTED_WITH_SUGGESTED_BSS_TRANSITION status code.

10. An access point (AP) multi-link device (MLD), comprising:
a processor;
two or more affiliated APs, each affiliated AP operative to establish a corresponding link with an affiliated station of a non-AP MLD, and
a memory communicatively coupled to the processor, wherein the memory comprises a Multi-Link Operation (MLO) management logic configured to perform operations comprising:
establishing, by the AP MLD, an association with a non-AP MLD,
wherein the establishing comprises:
receiving, on a first AP of the two or more affiliated APs of the AP MLD, an association request from the non-AP MLD, wherein the association request includes an indication of one or more requested links of the AP MLD;
determining, by the AP MLD, whether to reject the association request; and
responsive to determining by the AP MLD to reject the association request:
sending an association response using the first AP, the association response indicating a rejection of the association request and comprising a Neighbor Report element,
wherein the Neighbor Report element includes a basic multi-link element including data indicating one more suggested links of a suggested AP MLD; and
wherein the association response including the neighbor report element is operative to suggest to the non-AP MLD to attempt an association with the suggested AP MLD including at least one of the one or more suggested links.

11. The AP MLD of claim 10 wherein the one or more suggested links are a subset of the links of the suggested AP MLD.

12. The AP MLD of claim 10 wherein the suggested AP MLD is the AP MLD.

13. The AP MLD of claim 12 wherein the one or more suggested links are a subset of the links of the suggested AP MLD.

14. The AP MLD of claim 10 wherein the suggested AP is a second AP MLD neighboring the AP MLD.

15. The AP MLD of claim 10, the operations further comprising:
responsive to accepting the association request, transmitting an association response indicating acceptance of the association and at least one of the one or more requested links.

16. The AP MLD of claim 15, the operations further comprising maintaining the association with the non-AP MLD, the association including the one or more requested links accepted by the AP MLD.

17. The AP MLD of claim 10 wherein association response includes a second Neighbor Report element, wherein each of the Neighbor Report element and the second Neighbor Report element includes a preference value.

18. The AP MLD of claim 10 wherein the association response indicating the rejection comprises a REJECTED_WITH_SUGGESTED_BSS_TRANSITION status code.

19. A non-transitory computer readable storage medium comprising instructions that when executed configure one or more processors of an access point (AP) multi-link device (MLD) to perform operations comprising:
establishing, by the AP MLD, an association with a non-AP MLD,
the AP MLD comprising two or more affiliated APs, each affiliated AP operative to establish a corresponding link with an affiliated station of the non-AP MLD,
wherein the establishing comprises:
receiving, on a first AP of the two or more affiliated APs of the AP MLD, an association request from the non-AP MLD, wherein the association request includes an indication of one or more requested links of the AP MLD;
determining, by the AP MLD, whether to reject the association request; and
responsive to determining by the AP MLD to reject the association request:
sending an association response using the first AP, the association response indicating a rejection of the association request and comprising a Neighbor Report element,
wherein the Neighbor Report element includes a basic multi-link element including data indicating one more suggested links of a suggested AP MLD; and
wherein the association response including the neighbor report element is operative to suggest to the non-AP MLD to attempt an association with the suggested AP MLD including at least one of the one or more suggested links.

20. The non-transitory computer readable storage medium of claim 19 wherein the suggested AP MLD is the AP MLD, and wherein the one or more suggested links are a subset of the links of the suggested AP MLD.
